(19) United States
(12) Patent Application Publication
(10) Pub. No.: US 2026/0074855 A1
(43) Pub. Date: Mar. 12, 2026

(54) INDICATION OF FREQUENCY-DOMAIN COMPENSATION FACTORS IN RECONFIGURABLE INTELLIGENT SURFACE-ASSISTED SENSING

(71) Applicant: QUALCOMM Incorporated, San Diego, CA (US)

(72) Inventors: Min HUANG, Beijing (CN); Mingxi YIN, Beijing (CN); Hao XU, Beijing (CN)

(21) Appl. No.: 19/102,326

(22) PCT Filed: Sep. 23, 2022
(86) PCT No.: PCT/CN2022/120736

§ 371 Date: Feb. 7, 2025

(51) Int. Cl. H04L 5/00; H04L 43/062; H04W 72/0453

(52) U.S. Cl. CPC H04L 5/0048; H04L 43/062; H04W 72/0453

(57) ABSTRACT

A first network node may be configured to transmit a configuration of a set of resources for at least one sensing signal. Each of the set of resources is associated with at least one of an incident beam direction angle of a wireless device or a reflection beam direction angle of the wireless device. The wireless device may be configured to receive the configuration of the set of resources for the at least one sensing signal. The wireless device may be configured to transmit an indication of at least one frequency-domain compensation factor for each of the set of resources based on the configuration. The first network node may be configured to transmit the at least one sensing signal based on the configuration of the set of resources. The wireless device may be configured to receive and forward the at least one sensing signal based on the set of resources.

### TECHNICAL FIELD

The present disclosure relates generally to communication systems, and more particularly, to a reconfigurable intelligent surface (RIS) system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network node are provided. The apparatus may transmit a configuration of a set of resources for at least one sensing signal. Each of the set of resources may be associated with at least one of an incident beam direction angle of a wireless device or a reflection beam direction angle of the wireless device. The apparatus may transmit the at least one sensing signal based on the configuration of the set of resources.

In an aspect of the disclosure, a method, a computer-readable medium, and an apparatus at a wireless device are provided. The apparatus may receive a configuration of a set of resources for at least one sensing signal. Each of the set of resources may be associated with at least one of: an incident beam direction angle of the wireless device or a reflection beam direction angle of the wireless device. The apparatus may transmit an indication of at least one frequency-domain compensation factor for each of the set of resources based on the configuration. The apparatus may receive and forward the at least one sensing signal based on the set of resources.

In an aspect of the disclosure, a method, a computer-readable medium, and an apparatus at a second network node are provided. The apparatus may receive an indication of at least one frequency-domain compensation factor for each of a set of resources for at least one sensing signal. Each of the set of resources may be associated with at least one of: an incident beam direction angle of a wireless device or a reflection beam direction angle of the wireless device. The apparatus may receive the at least one sensing signal via the wireless device. The apparatus may perform a sensing operation for the at least one sensing signal based on the indication of the at least one frequency-domain compensation factor for each of the set of resources.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a RIS configured to receive and forward one or more signals from a first network node to a second network node, in accordance with various aspects of the present disclosure.

FIG. 5A is a diagram illustrating an example of a RIS configured to receive and forward one or more signals from a first network node to a second network node about an obstacle, in accordance with various aspects of the present disclosure.

FIG. 5B is a diagram illustrating an example of a RIS configured to receive and forward one or more signals from a first network node to a second network node via a target object, in accordance with various aspects of the present disclosure.

FIG. 5C is a diagram illustrating an example of a RIS configured to receive and forward one or more signals from a first network node to the first network node via a target object, in accordance with various aspects of the present disclosure.

FIG. 6 is a connection flow diagram illustrating an example of a RIS configured to receive and forward a sensing signal from a first network node to a second network node, in accordance with various aspects of the present disclosure.

FIG. 7 is a connection flow diagram illustrating an example of a RIS configured to receive and forward a sensing signal from a first network node to a second network node, where the first network node and the second network node are configured to communicate directly with one another, in accordance with various aspects of the present disclosure.

FIG. 8 is a connection flow diagram illustrating an example of a RIS configured to receive and forward a sensing signal from a first network node to a second network node via a target object, in accordance with various aspects of the present disclosure.

FIG. 9 is a connection flow diagram illustrating an example of a RIS configured to receive and forward a sensing signal from a first network node to a second network node via a target object, where the first network node and the second network node are configured to communicate directly with one another, in accordance with various aspects of the present disclosure.

FIG. 10 is an alternative connection flow diagram illustrating an example of a RIS configured to receive and forward a sensing signal from a first network node to a second network node via a target object, where the first network node and the second network node are configured to communicate directly with one another, in accordance with various aspects of the present disclosure.

FIG. 11 is a connection flow diagram illustrating an example of a RIS configured to receive and forward a sensing signal from a first network node to the first network node via a target object, in accordance with various aspects of the present disclosure.

FIG. 12 is a connection flow diagram illustrating an example of a RIS configured to receive and forward a sensing signal from a first network node to the first network node via a target object, in accordance with various aspects of the present disclosure.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a diagram illustrating an example of a hardware implementation for an example apparatus and/or network entity.

FIG. 22 is a diagram illustrating an example of a hardware implementation for an example network entity.

FIG. 23 is a diagram illustrating an example of a hardware implementation for an example network entity.

### DETAILED DESCRIPTION

When reflecting a signal using a wireless device, such as a reconfigurable intelligent surface (RIS), the amplitude and phase of a reflection coefficient at each meta-element may vary with frequency. The amplitude and phase reflection coefficients may be referred to as frequency-based characteristics. Such frequency-based characteristics may disturb propagation delay and target object distance estimation, and may reduce estimation accuracy if not accounted for. A wireless device may estimate frequency-based characteristics for each of a set of sensing signal resources based on at least one of an incident beam direction angle of each sensing signal resource at the wireless device or a reflection beam direction angle of each sensing signal resource at the wireless device. A sensing signal receiver may increase the accuracy of its sensing by sensing a set of sensing signal resources using the estimated frequency-based characteristics for each of a set of sensing signal resources.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

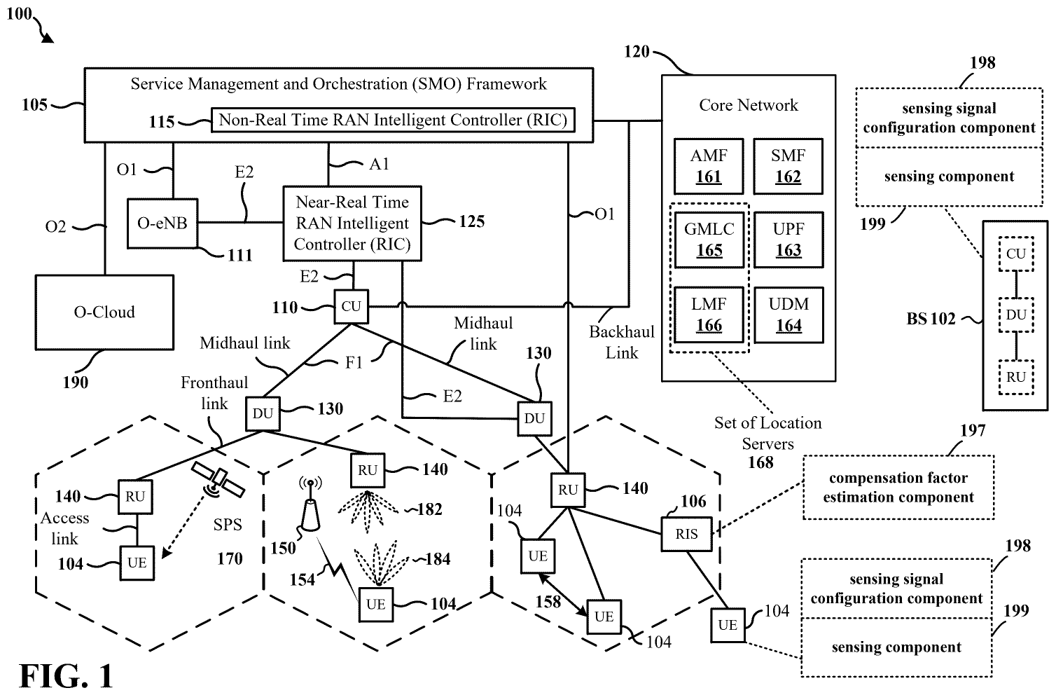

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

A RIS 106 may be a meta-surface configured to receive signal from a base station 102 or an RU 140 of a base station 102. The RIS 106 may be configured to reflect the signal to a desired direction for example to the RU 140 or to the UE 104. The RIS may have one or more RIS elements, whose electromagnetic reflection responses may be controlled by programmable P and N region (PIN) diodes. The RIS 106 may also be configured to sense attributes of a signal received by the RIS 106, such as an angle of arrival (AoA)

Referring again to FIG. 1, in certain aspects, the UE 104 or the base station 102 may have a sensing signal configuration component 198 configured to transmit a configuration of a set of resources for at least one sensing signal. Each of the set of resources may be associated with at least one of an incident beam direction angle of a wireless device or a reflection beam direction angle of the wireless device. The sensing signal configuration component 198 may be configured to transmit the at least one sensing signal based on the configuration of the set of resources. In certain aspects, the UE 104 or the base station 102 may have a sensing component 199 configured to receive an indication of at least one frequency-domain compensation factor for each of a set of resources for at least one sensing signal. Each of the set of resources may be associated with at least one of: an incident beam direction angle of a wireless device or a reflection beam direction angle of the wireless device. The sensing component 199 may be configured to receive the at least one sensing signal via the wireless device. The sensing component 199 may be configured to perform a sensing operation for the at least one sensing signal based on the indication of the at least one frequency-domain compensation factor for each of the set of resources. In certain aspects, the RIS 106 may have a compensation factor estimation component 197 configured to receive a configuration of a set of resources for at least one sensing signal. Each of the set of resources may be associated with at least one of: an incident beam direction angle of the wireless device or a reflection beam direction angle of the wireless device. The compensation factor estimation component 197 may be configured to transmit an indication of at least one frequency-domain compensation factor for each of the set of resources based on the configuration. The compensation factor estimation component 197 may be configured to receive and forward the at least one sensing signal based on the set of resources. Although the following description may be focused on RIS devices, the concepts described herein may be applicable to any device capable of sensing a portion of an incident wave at a first angle and reflecting or retransmitting a portion of an incident wave at a second angle, such as a UE or a roadside unit (RSU). Although the following description may be focused on 5G NR, the concepts described herein may be applicable to other similar areas, such as LTE, LTE-A, CDMA, GSM, and other wireless technologies capable of transmitting wireless signals that may be reflected and/or sensed by a RIS device or a RIS-like device.

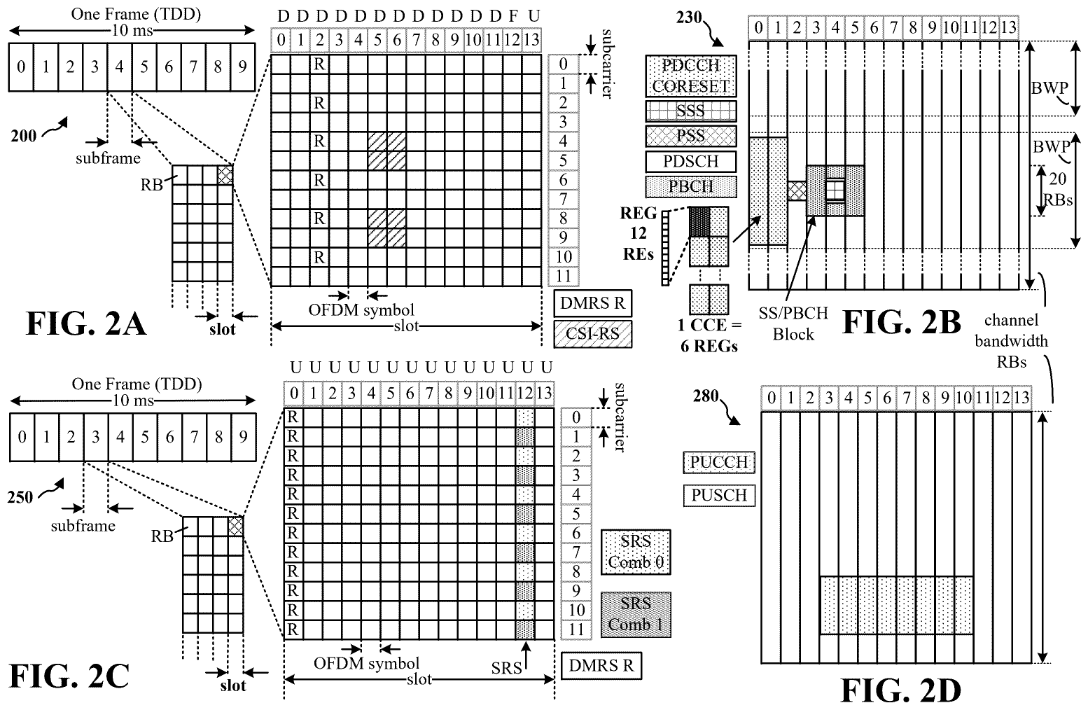

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

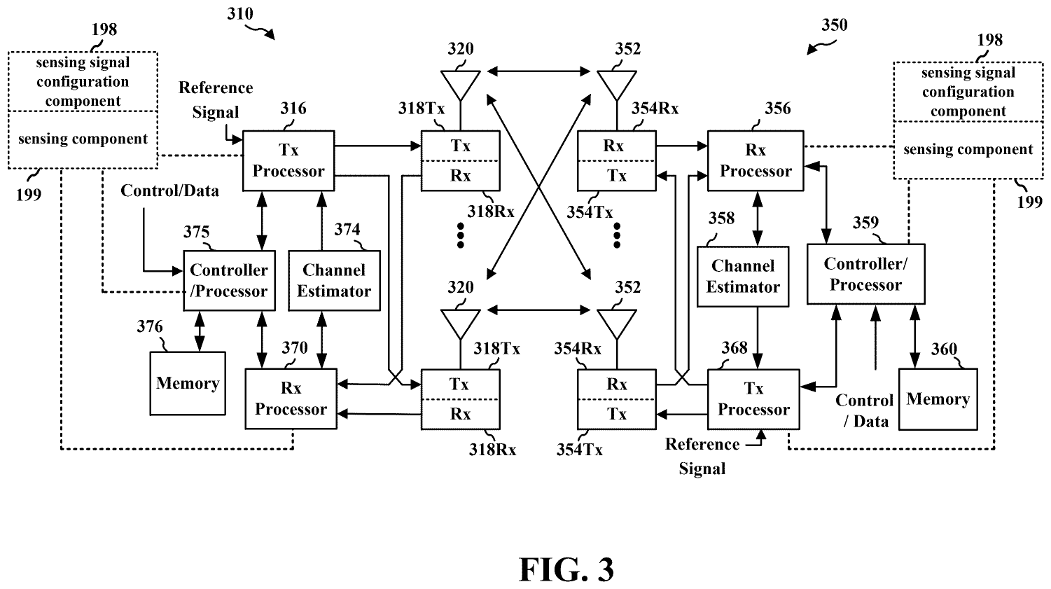

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the sensing signal configuration component 198 of FIG. 1.

At least one of the Tx processor 368, the Rx processor 356, and the controller/processor 359 may be configured to perform aspects in connection with the sensing component 199 of FIG. 1.

At least one of the Tx processor 316, the Rx processor 370, and the controller/processor 375 may be configured to perform aspects in connection with the sensing signal configuration component 198 of FIG. 1.

At least one of the Tx processor 316, the Rx processor 370, and the controller/processor 375 may be configured to perform aspects in connection with the sensing component 199 of FIG. 1.

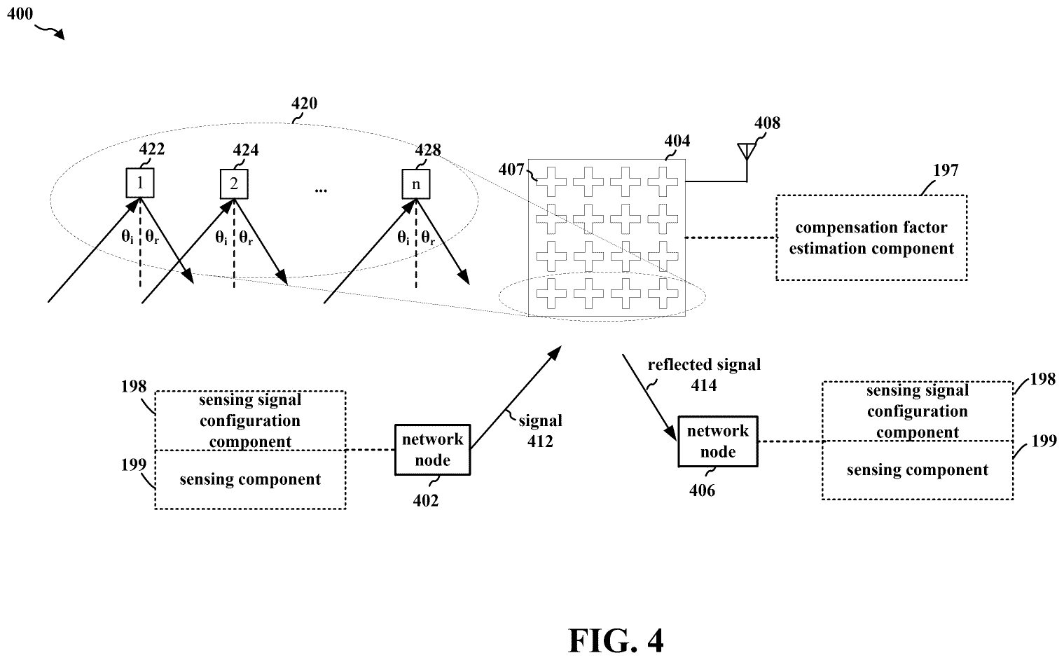

FIG. 4 is a diagram 400 illustrating an example of a RIS 404 configured to receive a signal 412 from a network node 402, and forward (e.g., reflect) a signal 414 towards a network node 406. The network node 402 may be a wireless device configured to transmit the signal 412, such as the UE 104 or the base station 102 in FIG. 1. The network node 406 may be a wireless device configured to receive the signal 414, such as the UE 104 or the base station 102 in FIG. 1. The RIS 404 may have an antenna 408 that may be used to transmit data, such as an indication of a frequency-domain compensation factor, to the network node 402 or to the network node 406. One or more of the meta-elements 407 of a meta-surface of the RIS 404 may be configured to reflect the signal 412 as the signal 414. One or more of the meta-elements 407 of the RIS 404 may be configured to sense one or more attributes of the signal 412, such as an AoA or a signal strength.

The RIS 404 may have an ultrathin surface inlaid with a plurality of meta-elements 407, which may also be referred to as sub-wavelength scatters or RIS elements. The electromagnetic response, such as phase shifts, of each of the meta-elements 407 may be controlled by programmable PIN diodes or varactor diodes. Each of the meta-elements 407 may be configured to reflect the signal 412 to a desired direction. The configuration of one or more reflective elements may be used to aim a signal 412 in a desired direction. For example, one or more reflection coefficients of one of the meta-elements 407 may be changed to alter a direction that the signal 414 is centered upon. For example, a first coefficient may be altered to change an amplitude of the signal 414 and a second coefficient may be altered to shift a phase of the signal 414. The configuration of the meta-elements 407 of the RIS 404 may depend on the knowledge of the direction of the incident wave of the signal 412. In other words, the accuracy of where a meta-element of the meta-elements 407 centers or aims the signal 414 may be increased using information about the direction that the signal 412 approaches the meta-elements 407 from, or an AoA of the signal 412 relative to the meta-elements 407.

The RIS 404 may allow the network node 402 and the network node 406 to communicate with one another using wireless signals even if there may not be a line of sight (LOS) path between the transceivers of the network node 402 and the network node 406. Without the RIS 404, the network node 402 may have limited covering distance due to in-return transmission. Without the RIS 404, the network node 402 may have a coverage hole in transmitting to wireless devices, such as network node 406, if there is no LOS link between the network node 402 and a transmission target. Without the RIS 404, the network node 402 may not have sufficient positioning reference points, as one network node may provide one reference point. With the RIS 404, the RIS 404 may extend the covering distance via RIS beamforming. With the RIS 404, the RIS 404 may eliminate a coverage hole by using the RIS 404 as a relay point. The RIS 404 may have flexible deployment to have a LOS link to the coverage hole of the network node 402. With the RIS 404, an extra reference point with the position of the RIS 404 may be added as a positioning reference points for positioning measurements.

The signal 412 may be transmitted towards the RIS 404 from the network node 402 at an incident angle θᵢ, and the signal 414 may be reflected or forwarded towards the network node 406 from the RIS 404 at a reflection angle θᵣ. The incident angle θᵢ and the reflection angle θᵣ may be estimated by the network node 402 in any suitable manner, for example based on a location indication of the network node 402, a location indication of the RIS 404, and a location indication of the network node 406. The network node 402 may transmit a query to a LMF, such as the LMF 166 in FIG. 1, to retrieve location information associated with the network node 402, the RIS 404, and/or the network node 406, respectively. In some aspects, at least one of the network node 402, the RIS 404, and/or the network node 406 may perform positioning using one or more positioning reference signals in order to retrieve location information associated with the network node 402, the RIS 404, and/or the network node 406, respectively. In some aspects, at least one of the network node 402, the RIS 404, and/or the network node 406 may perform sensing using one or more sensing reference signals in order to retrieve location information associated with the network node 402, the RIS 404, and/or the network node 406, respectively. In some aspects, the location/position of the network node 402, the RIS 404, and/or the network node 406 may be fixed.

A section 420 of the RIS 404 may have an element 422, an element 424, and an element 428. The elements may be identified as elements 1 to n. The signal 412 may approach each of the elements 422, 424, and 428 at an incident angle θᵢ and may be reflected by each of the elements 422, 424, and 428, respectively, at a reflection angle θᵣ. The equivalent channel response value of the nth element, such as the element 428, of the RIS 404 at a reflection angle θₘ may be estimated as

$${h}_{n} = {e}^{j \frac{2 π {d}_{n}}{λ} ( {sin θ}_{i} + {sin θ}_{r} )} \times {α}_{n} {e}^{j {φ}_{n}} .$$

αₙe^{jφ}^{ₙ} may be the reflection coefficient of the element n, such as the element 428.

dₙ may be the distance between the nth element to the first element, such as the distance between the element 428 and the element 422.

j may be a complex value symbol.

λ may be the wavelength of the signal reflected off of the element n, such as the element 428.

αₙ may be an amplitude of a reflection coefficient at the nth element. On may be a phase of the reflection coefficient at the nth element.

The overall equivalent channel response value of all of the elements of the RIS 404 at the reflection angle θᵣ may be estimated as

$$h = {\sum }_{n = 1}^{N} {h}_{n} = {\sum }_{n = 1}^{N} {e}^{j \frac{2 π {d}_{n}}{λ} ( {sin θ}_{i} + {sin θ}_{r} )} \times {α}_{n} {e}^{j {φ}_{n}}$$

If the reflection coefficient satisfies αₙ≡α, then the value of φₙ may be estimated as

$${φ}_{n} = - \frac{2 π {d}_{n}}{λ} ( {sin θ}_{i} + {sin θ}_{r} )$$

The reflected beam may point to the direction θᵣ.

The coefficient amplitude and phase values of each of the meta-elements 407 of the RIS 404 may be obtained from a limited candidate reflection coefficient set {(a₁, φ₁), (a₂, φ₂), . . . , (a_{M}, φ_{M})} by different configurations, where aₘ may be the amplitude of the mth candidate reflection coefficient and φₘ may be the phase of the mth candidate reflection coefficient. In other words, the actual beam shape may deviate from the ideal estimated beam direction θᵣ. The larger the number of meta-elements 407 of RIS 404, the closer the actual beam shape may be to the ideal beam, which may increase the accuracy of the estimated beam direction Or.

For the RIS 404, the amplitude and the phase of reflection coefficient at each of the meta-elements 407 may vary with frequency. The amplitude and/or the phase relationship with frequency characteristics may depend on the hardware structure of the RIS 404. In some aspects, the coefficient phase of each meta-element may change substantially linearly with the frequency. In other aspects, the coefficient phase of each meta-element may change non-linearly with the frequency. In some aspects, the coefficient amplitude may have a slight variance with frequency. For each meta-element configuration, the reflection coefficient amplitude and phase may be frequency-dependent, and may be expressed by

$$ψ ( f ) = \{ ( {a}_{1} ( f ) , {ϕ}_{1} ( f ) ) , ( {a}_{2} ( f ) , {ϕ}_{2} ( f ) ) , … , ( {a}_{M} ( f ) , {ϕ}_{M} ( f ) ) \}$$

If the RIS 404 is configured to reflect signals, such frequency-dependent characteristics (e.g., amplitude, phase) at the RIS 404 may be involved into the equivalent channel status value. In other words, the frequency-dependent characteristics at the RIS 404 may not impact operation at the transceiver of the RIS 404. If the RIS 404 is configured to sense signals, such frequency-dependent characteristics at the RIS 404 may disturb the estimation of the propagation delay and target object distance. This may reduce the estimation accuracy. Such issues may be worse if the signal 412 has a large bandwidth.

Without such frequency-dependent characteristics, if there is a path with a delay t, the estimated channel status value at the kth subcarrier may be estimated as

$${r}_{k} = h \times {e}^{- j 2 π τ {f}_{k}}$$

The delay τ may be estimated with greater accuracy by performing an inverse fast Fourier transform (IFFT) on {rₖ} of all of the subcarriers.

With such frequency-dependent characteristics, the overall equivalent channel response value associated with the RIS 404 may be different for multiple subcarriers. In other words, the estimated channel status value at the kth subcarrier may be estimated as

$${r}_{k} = {h}_{k} \times {e}^{- j 2 π τ {f}_{k}}$$

Where hₖ may be the overall equivalent channel response value at the kth subcarrier. Because hₖ may vary in a frequency domain due to the frequency-dependent characteristics of RIS reflection coefficients, the delay t may not be accurately estimated by performing IFFT on {rₖ} of all of the subcarriers without taking into consideration one or more of the frequency-domain compensation factors.

In order to improve estimates of sensing signals reflected using a RIS, the transmitting network node may configure sensing signal resources to the RIS. Each sensing signal resource may be associated with an incident beam direction angle (e.g., θᵢ) and a reflection beam direction angle (e.g., θᵣ). The network node may transmit an incident beam direction angle (θᵢ) and/or a reflection beam direction angle (θᵣ) to the RIS for each sensing signal resource, for example bands or subbands of the sensing signals. The RIS may calculate and indicate the respective frequency-domain compensation factors of each sensing signal resource to the sensing signal receiver and transmit the frequency-domain compensation factors to a sensing signal receiver as gₖ(θ_{r,l}) at each subcarrier k and sensing signal resource l. In some aspects, the RIS may calculate an equivalent channel response value hₙ of each element n at the RIS, a reflection coefficient amplitude and phase for each frequency ψ(f), and/or an estimated channel status value rₖ at each subcarrier k, and transmit such calculated values to the sensing signal receiver for sensing. The sensing signal receiver may perform the sensing based on the indication of the respective frequency-domain compensation factors. The sensing may include estimating the propagation delay and the distance with a target object. For example, the network node 402 transmitting the signal 412 to the RIS 404 may configure sensing signal resources to the RIS 404. The RIS 404 may then calculate and indicate the respective frequency-domain compensation factors of each sensing signal resource to the network node 406. The network node 406 may perform the sensing based on the indication received from the RIS 404. The disturbance due to frequency-dependent characteristics of the reflection coefficients of RIS meta-elements may be mitigated by enabling the RIS to indicate frequency-domain compensation factors to a signal receiver so that the signal receiver may perform sensing using the frequency-domain compensation factors. For example, the signal receiver may more accurately estimate a delay value by performing IFFT based on a set of frequency-domain compensation factors. Enabling a signal receiver to perform sensing using received frequency-domain compensation factors may improve RIS-based sensing with a large bandwidth sensing signal.

The network node 402 or the network node 406 may have a sensing signal configuration component 198 configured to transmit a configuration of a set of resources for at least one sensing signal. Each of the set of resources may be associated with at least one of an incident beam direction angle of a wireless device or a reflection beam direction angle of the wireless device. The sensing signal configuration component 198 may be configured to transmit the at least one sensing signal based on the configuration of the set of resources.

The network node 402 or the network node 406 may have a sensing component 199 configured to receive an indication of at least one frequency-domain compensation factor for each of a set of resources for at least one sensing signal. Each of the set of resources may be associated with at least one of: an incident beam direction angle of a wireless device or a reflection beam direction angle of the wireless device. The sensing component 199 may be configured to receive the at least one sensing signal via the wireless device. The sensing component 199 may be configured to perform a sensing operation for the at least one sensing signal based on the indication of the at least one frequency-domain compensation factor for each of the set of resources.

The RIS 404 may have a compensation factor estimation component 197 configured to receive a configuration of a set of resources for at least one sensing signal. Each of the set of resources may be associated with at least one of: an incident beam direction angle of the wireless device or a reflection beam direction angle of the wireless device. The compensation factor estimation component 197 may be configured to transmit an indication of at least one frequency-domain compensation factor for each of the set of resources based on the configuration. The compensation factor estimation component 197 may be configured to receive and forward the at least one sensing signal based on the set of resources.

The compensation factor estimation component 197 may be within a processor of the RIS 404. The compensation factor estimation component 197 may be one or more hardware components specifically configured to carry out the stated processes/algorithm, implemented by one or more processors configured to perform the stated processes/algorithm, stored within a computer-readable medium for implementation by one or more processors, or some combination thereof. In one configuration, the RIS 404 may include means for receiving a configuration of a set of resources for at least one sensing signal. The RIS 404 may include means for transmitting an indication of at least one frequency-domain compensation factor for each of the set of resources based on the configuration. The RIS 404 may include means for receiving and forwarding the at least one sensing signal based on the set of resources. The RIS 404 may include means for receiving and forwarding the at least one sensing signal based on the set of resources by reflecting the at least one sensing signal based on the set of resources. The RIS 404 may include means for estimating the at least one frequency-domain compensation factor for each of the set of resources based on at least one of the incident beam direction angle of the wireless device or the reflection beam direction angle of the wireless device. The RIS 404 may include means for transmitting the indication of the at least one frequency-domain compensation factor for each of the set of resources based on the configuration by transmitting the indication based on the estimation of the at least one frequency-domain compensation factor. The RIS 404 may include means for estimating a frequency-domain compensation factor at an nth element of the wireless device as

$${h}_{n} = {e}^{j \frac{2 π d n}{λ} ( {sin θ}_{i} + {sin θ}_{r} )} \cdot {α}_{n} {e}^{j {φ}_{n}} .$$

The RIS 404 may include means for estimating the at least one frequency-domain compensation factor as a product of a first frequency-domain compensation factor of an DL reflection and a second frequency-domain compensation factor of a UL reflection. The RIS 404 may include means for receiving the configuration of the set of resources for the at least one sensing signal by receiving the configuration from a first network node. The RIS 404 may include means for transmitting the indication of the at least one frequency-domain compensation factor by transmitting the indication to a second network node. The RIS 404 may include means for receiving and forwarding the at least one sensing signal based on the set of resources by receiving the at least one sensing signal from the first network node. The RIS 404 may include means for receiving and forwarding the at least one sensing signal based on the set of resources by forwarding the at least one sensing signal to the second network node. The RIS 404 may include means for forwarding the at least one sensing signal to the second network node by forwarding the at least one sensing signal to the second network node via a target object. The RIS 404 may include means for receiving the configuration of the set of resources for the at least one sensing signal by receiving the configuration from a first network node. The RIS 404 may include means for transmitting the indication of the at least one frequency-domain compensation factor by transmitting the indication to the first network node. The RIS 404 may include means for receiving and forwarding the at least one sensing signal based on the set of resources by receiving the at least one sensing signal from the first network node. The RIS 404 may include means for receiving and forwarding the at least one sensing signal based on the set of resources by forwarding the at least one sensing signal to the second network node. The RIS 404 may include means for forwarding the at least one sensing signal to the second network node by forwarding the at least one sensing signal to the second network node via a target object. The RIS 404 may include means for receiving the configuration of the set of resources for the at least one sensing signal by receiving the configuration from a first network node. The RIS 404 may include means for transmitting the indication of the at least one frequency-domain compensation factor by transmitting the indication to the first network node. The RIS 404 may include means for receiving and forwarding the at least one sensing signal based on the set of resources by receiving the at least one sensing signal from the first network node. The RIS 404 may include means for receiving and forwarding the at least one sensing signal based on the set of resources by forwarding the at least one sensing signal to the first network node. The RIS 404 may include means for forwarding the at least one sensing signal to the first network node by forwarding the at least one sensing signal to the first network node via a target object that reflects the at least one sensing signal back to the wireless device. The RIS 404 may include means for estimating the at least one frequency-domain compensation factor for each of the set of resources based on at least one of the incident beam direction angle of the wireless device or the reflection beam direction angle of the wireless device. The RIS 404 may include means for transmitting the indication of the at least one frequency-domain compensation factor for each of the set of resources based on the configuration by transmitting the indication based on the estimation of the at least one frequency-domain compensation factor. The means may be the compensation factor estimation component 197 of the RIS 404 configured to perform the functions recited by the means.

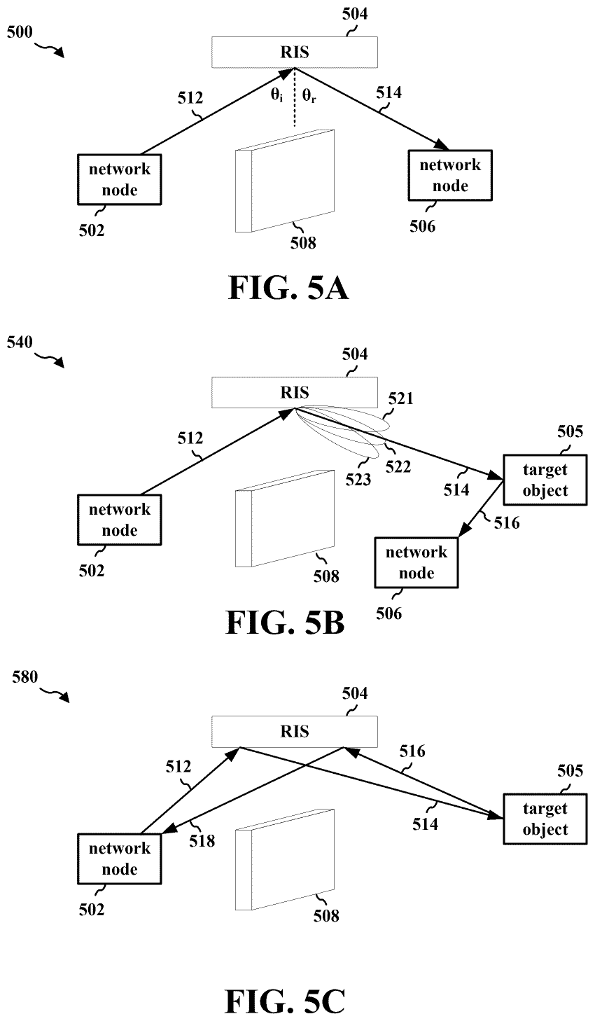

FIG. 5A is a diagram 500 illustrating a RIS 504 configured to circumvent a signal block 508 by reflecting a signal 512 from a network node 502 to a network node 506 via a signal 514. The network node 502 may configure sensing signal resources of the signal 512 to the RIS 504. The network node 502 may be a base station, such as the base station 102 in FIG. 1. Each sensing signal resource may be associated with an incident beam direction angle (e.g., θᵢ) and a reflection beam direction angle (e.g., θᵣ). The RIS 504 may calculate and indicate the respective frequency-domain compensation factors of each sensing signal resource to the network node 506 as the sensing signal receiver. The network node 506 may be a UE, such as the UE 104 in FIG. 1, or a base station, such as the base station 102 in FIG. 1. The network node 506 may perform sensing based on the indication of the respective frequency-domain compensation factors of each sensing signal resource. The sensing may estimate the propagation delay of the signal 514 by reflecting off of the RIS 504. Such a system may also be used to locate a target object, for example if the network node 506 was a UE that is not in a fixed location.

FIG. 5B is a diagram 540 illustrating a RIS 504 configured to circumvent a signal block 508 by reflecting a signal 512 from a network node 502 to a network node 506 via a signal 514 that reflects off of the target object 505 as the signal 516 to the network node 506. The network node 502 may configure sensing signal resources of the signal 512 to the RIS 504. The network node 502 may be a base station, such as the base station 102 in FIG. 1. Each sensing signal resource may be associated with an incident beam direction angle (e.g., θᵢ) and a reflection beam direction angle (e.g., θᵣ). If the position of the network node 502 and the RIS 504 are fixed, the network node 502 may estimate the position of the RIS 504 and indicate the fixed incident angle θᵢ to the RIS 504.

The RIS 504 may calculate the respective frequency-domain compensation factors of each sensing signal resource. The RIS 504 may sweep the reflection beam of the signal 514 and may calculate corresponding frequency-domain compensation factors. For example, the RIS 504 may sweep the reflection beam of the signal 514 from a first beam 521 to a second beam 522 to a third beam 523. The RIS 504 may select the corresponding reflection coefficient of each meta-element of the RIS 504 to change the reflection angles θᵣ in multiple sensing signal resources, respectively. The RIS 504 may estimate the frequency-domain compensation factors based on the reflection coefficients of all of the meta-elements of the RIS 504.

The signal 512 may be OFDM-based. The RIS 504 may assume that the OFDM-based sensing signal is transmitted at each sensing signal resource. In other words, each sensing signal resource may contain a plurality of REs of one OFDM symbol. For each beam direction, the RIS 504 may select a reflection coefficient of each meta-element from a set of y candidate reflection coefficients.

The RIS 504 may use the set of y reflection coefficients to make a vector of all of the selected values α₁e^{jφ}^{₁}, α₂e^{jφ}^{₂}, . . . , α_{N}e^{jφ}^{_{N}}] the most similar to the theoretical values

$$α \times [ {e}^{- j \frac{2 π {d}_{1}}{λ} ( {sin θ}_{i} + {sin θ}_{r} )} , {e}^{- j \frac{2 π {d}_{2}}{λ} ( {sin θ}_{i} + {sin θ}_{r} )} , … , {e}^{- j \frac{2 π {d}_{N}}{λ} ( {sin θ}_{i} + {sin θ}_{r} )} ] .$$

A selected value that is the most similar to a theoretical value may be a selected value that has the largest correlation coefficient with the theoretical value. The overall equivalent channel response value may be estimated as

$$h ( {θ}_{r} ) = {\sum }_{n = 1}^{N} {h}_{n} ( {θ}_{r} ) = {\sum }_{n = 1}^{N} {e}^{j \frac{2 π {d}_{n}}{λ} ( {sin θ}_{i} + {sin θ}_{r} )} \times {α}_{n} {e}^{j {φ}_{n}}$$

The equivalent channel response value h(θᵣ) may be dependent upon the reflection angle θᵣ.

Because the values in the set of ψ candidate reflection coefficients may be dependent on the frequency, the values of h at multiple subcarriers may be different. The values of h at multiple subcarriers may be defined as

$${\{ {h}_{k} ( {θ}_{r} ) \}}_{k = 1}^{K}$$

k may be the index of subcarriers within a sensing signal resource.

Because the values of all of the involved parameters may be known by the RIS 504, the RIS 504 may calculate the frequency-domain compensation factors at each sensing signal resource with the reflection beam direction θ_{r,l} defined as

$${g}_{k} ( {θ}_{r , l} ) = {( {h}_{k} ( {θ}_{r , l} ) )}^{- 1}$$

k may range from 1 to K. l may be the index of the sensing signal resource.

The RIS 504 may indicate the respective frequency-domain compensation factors of each sensing signal resource to the network node 506 as the sensing signal receiver. The network node 506 may be a UE, such as the UE 104 in FIG. 1, or a base station, such as the base station 102 in FIG. 1. For example, the frequency-domain compensation factors may be transmitted as the factors for the first beam 521, the second beam 522, and the third beam 523 as Table 1 below:

TABLE 1
exemplary frequency-domain compensation factor table

| index of sensing | reflection beam direction | frequency-domain |
|---|---|---|
| signal resource | angle (optional) | compensation factor |
| 1 | θ_{r, 1} | g₁ |
| 2 | θ_{r, 2} | g₂ |
| 3 | θ_{r, 3} | g₃ |

In some aspects, the RIS 504 may indicate both the frequency-domain compensation factors and the reflection beam direction angle to the network node 506. In other aspects the RIS 504 may indicate the frequency-domain compensation factors without indicating the reflection beam direction angle to the network node 506. The RIS 504 may indicate the set of frequency-domain compensation factors associated with the set of sensing signal resources to the network node 506 statically or semi-statically. The RIS 504 may indicate each frequency-domain compensation factor for each sensing signal resource l as gₖ(θ_{r,l}). Each frequency-domain compensation factor gₖ(θ_{r,l}) may be associated with a reflection direction θ_{r,l}. l may range from 1 to L sensing signal resources.

The RIS 504 may periodically or semi-persistently configure the swept reflection beam directions

$${\{ {θ}_{r , l} \}}_{l = 1}^{L} .$$

The indicated frequency-domain compensation factors gₖ(θ_{r,l}) may hold effective for a long period of time, such as minutes or hours, which may reduce the signaling overhead. The signaling of the frequency-domain compensation factors gₖ(θ_{r,l}) may be via RRC configuration or a MAC control element (MAC-CE) signal.

The frequency-domain compensation factor for K subcarriers in the lth sensing signal resource

$${\{ {h}_{k} ( {θ}_{r} ) \}}_{k = 1}^{K}$$

may be quantized as

$${g}_{1} = [ {g}_{l , 1} , {g}_{l , 2} , … , {g}_{l , K} ] = Q ( 1 , \frac{{g}_{l , 2}}{{g}_{l , 1}} , … , \frac{{g}_{l , K}}{{g}_{l , 1}} )$$

The numbers of quantization bits for amplitude and/or phase may be configured by the network node 502.

The network node 502 may transmit a sensing signal as the signal 512 to the RIS 504. The RIS 504 may reflect the signal 512 as the signal 514 to the target object 505. The target object 505 may reflect the signal 514 as the signal 516 to the network node 506. The diagram 540 may illustrate an example of bi-static sensing. The target object 505 may be an unmanned aerial vehicle (UAV). The network node 506 may perform sensing based on the indication of the respective frequency-domain compensation factors of each sensing signal resource. The sensing may estimate the propagation delay and the distance with the target object 505. The network node 506 may compensate for an amplitude value or a phase value based on the frequency-domain compensation factor for each of the sensing signal resources.

For a sensing signal resource l, the network node 506 may receive the signal 516 at each subcarrier. The signal 516 may be represented as y_{l,k} where k may range from 1 to K subcarriers and l may represent the sensing signal resource. Based on each of the indicated frequency-domain compensation factors gₗ for each of the l sensing signal resources, the network node 506 may compensate the amplitude and phase by multiplying the frequency-domain compensation factor with the received signal. For example, the compensated signal may be estimated by z_{l,k}=y_{l,k}×g_{l,k}.

The network node 506 may perform IFFT for each

$${\{ {z}_{l , k} \}}_{k = 1}^{K} .$$

The network node 506 may estimate the delay value t corresponding to the path of the signal 512, the signal 514, and the signal 516 with one or more criterions. In one aspect, the network node 506 may, after performing IFFT, search for the maximum absolute value, to estimate the delay value τ. In one aspect, the network node 506 may estimate the delay value t corresponding to the path of the signal 512 with the largest channel gain. In response to the network node 506 estimating a delay value τ at more than one sensing signal resource l, the network node 506 may select a sensing signal resource l with the largest channel gain. The network node 506 may use the estimated delay value τ to further estimate other sensing metrics. For example, the network node 506 may estimate a distance with the target object 505 based on the estimated delay value τ. The network node 506 may report the sensing results, such as the estimated delay value τ or the estimated distance to the network node 502.

FIG. 5C is a diagram 580 illustrating a RIS 504 configured to circumvent a signal block 508 by reflecting a signal 512 from a network node 502 as the signal 514, which reflects off of the target object 505 as the signal 516, which reflects off of the RIS 504 as the signal 518 back to the network node 502. The diagram 580 may illustrate an example of mono-static sensing. The target object 505 may be UAV. The network node 502 may configure sensing signal resources of the signal 512 to the RIS 504. The network node 502 may be a base station, such as the base station 102 in FIG. 1. Each sensing signal resource may be associated with an incident beam direction angle (e.g., θᵢ) and a reflection beam direction angle (e.g., θᵣ). If the position of the network node 502 and the RIS 504 are fixed, the network node 502 may estimate the position of the RIS 504 and indicate the fixed incident angle θ; to the RIS 504.

The RIS 504 may calculate the respective frequency-domain compensation factors of each sensing signal resource. The RIS 504 may sweep the reflection beam of the signal 514 and may calculate corresponding frequency-domain compensation factors. The RIS 504 may also sweep the reflection beam of the signal 518 and may calculate corresponding frequency-domain compensation factors. The RIS 504 may select the corresponding reflection coefficient of each meta-element of the RIS 504 to change the reflection angles θᵣ in multiple sensing signal resources, respectively. The RIS 504 may estimate the frequency-domain compensation factors based on the reflection coefficients of all of the meta-elements of the RIS 504.

The signal 512 may be OFDM-based. The RIS 504 may assume that the OFDM-based sensing signal is transmitted at each sensing signal resource. In other words, each sensing signal resource may contain a plurality of REs of one OFDM symbol. For each beam direction, the RIS 504 may select a reflection coefficient of each meta-element from a set of ψ candidate reflection coefficients.

The RIS 504 may use the set of ψ candidate reflection coefficients to make a vector of all of the selected values [α₁e^{jφ}^{₁}, α₂e^{jφ}^{₂}, . . . , α_{N}e^{jφ}^{_{N}}] the most similar to the theoretical values

$$α \times [ {e}^{- j \frac{2 π {d}_{1}}{λ} ( sin {θ}_{i} + sin {θ}_{r} )} , {e}^{- j \frac{2 π {d}_{2}}{λ} ( sin {θ}_{i} + sin {θ}_{r} )} , … , {e}^{- j \frac{2 π {d}_{N}}{λ} ( sin {θ}_{i} + sin {θ}_{r} )} ] .$$

A selected value that is the most similar to a theoretical value may be a selected value that has the largest correlation coefficient with the theoretical value. The overall equivalent channel response value may be estimated as

$$h ( {θ}_{r} ) = {\sum }_{n = 1}^{N} {h}_{n} ( {θ}_{r} ) = {\sum }_{n = 1}^{N} {e}^{j \frac{2 π {d}_{n}}{λ} ( sin {θ}_{i} + sin {θ}_{r} )} \times {α}_{n} {e}^{j {φ}_{n}}$$

The equivalent channel response value h(θᵣ) may be dependent upon the reflection angle θᵣ.

Because the values in the set of ψ candidate reflection coefficients may be dependent on the frequency, the values of h at multiple subcarriers may be different. The values of h at multiple subcarriers may be defined as

$${\{ {h}_{k} ( {θ}_{r} ) \}}_{k = 1}^{K}$$

k may be the index of subcarriers within a sensing signal resource.

Because the values of all of the involved parameters may be known by the RIS 504, the RIS 504 may calculate the frequency-domain compensation factors at each sensing signal resource with the reflection beam direction θ_{r,l} defined as

$${g}_{k} ( {θ}_{r , l} ) = {( {h}_{k} ( {θ}_{r , l} ) )}^{- 1}$$

k may range from 1 to K. l may be the index of the sensing signal resource.

In some aspects, the RIS 504 may estimate each frequency-domain compensation factor as a product of an UL beam and a DL beam. In other words, the RIS 504 may estimate a frequency-domain compensation factor as the product of two components corresponding to the two RIS reflections, a first reflection of signal 512 to signal 514, and a second reflection of signal 516 to signal 518. The two reflections may also have two directions—an UL direction and a DL direction. The frequency domain compensation factor for each sensing signal resource/may be calculated as the product of the UL component and the DL component as follows

$${g}_{l , k} = {g}_{l , k}^{( DL )} {g}_{l , k}^{( UL )}$$

where

$${g}_{l , k}^{( DL )}$$

may be the frequency-domain compensation factor at subcarrier k and sensing signal resource l calculated in the DL direction and

$${g}_{l , k}^{( UL )}$$

may be the frequency-domain compensation factor at subcarrier k and sensing signal resource l calculated in the UL direction.

The RIS 504 may indicate the respective frequency-domain compensation factors of each sensing signal resource to the network node 502 as the sensing signal receiver. In some aspects, the RIS 504 may indicate both the frequency-domain compensation factors and the reflection beam direction angle to the network node 502. In other aspects the RIS 504 may indicate the frequency-domain compensation factors without indicating the reflection beam direction angle to the network node 502. The RIS 504 may indicate the set of frequency-domain compensation factors associated with the set of sensing signal resources to the network node 502 statically or semi-statically.

The network node 502 may transmit a sensing signal as the signal 512 to the RIS 504. The signal 512 may be reflected by the RIS 504 as the signal 514 to the target object 505. The signal 514 may be reflected by the target object 505 as the signal 516 to the RIS 504. The signal 516 may be reflected by the RIS 504 as the signal 518 to the network node 502. The network node 502 may perform sensing based on the indication of the respective frequency-domain compensation factors of each sensing signal resource. The sensing may estimate the propagation delay and the distance with the target object 505. The network node 502 may compensate for an amplitude inconsistence or a phase inconsistence based on the frequency-domain compensation factor for each of the sensing signal resources.

For a sensing signal resource l, the network node 502 may receive the signal 518 at each subcarrier. The signal 518 may be represented as y_{l,k} where k may range from 1 to K subcarriers and l may represent the sensing signal resource. Based on each of the indicated frequency-domain compensation factors gr for each of the l sensing signal resources, the network node 506 may compensate the inconsistent phase by multiplying the frequency-domain compensation factor with the received signal. For example, the compensated signal may be estimated by z_{l,k}=y_{l,k}×g_{l,k}.

The network node 502 may perform IFFT for each

$${\{ {z}_{l , k} \}}_{k = 1}^{K} .$$

The network node 502 may estimate the delay value τ corresponding to the path of the signal 512, the signal 514, the signal 516, and the signal 518 with one or more criterions. In one aspect, the network node 502 may estimate the delay value τ corresponding to the path of the signal 512 with the largest channel gain. In response to the network node 502 estimating a delay value τ at more than one sensing signal resource l, the network node 502 may select a sensing signal resource l with the largest channel gain. The network node 502 may use the estimated delay value τ to further estimate other sensing metrics. For example, the network node 502 may estimate a distance with the target object 505 based on the estimated delay value τ.

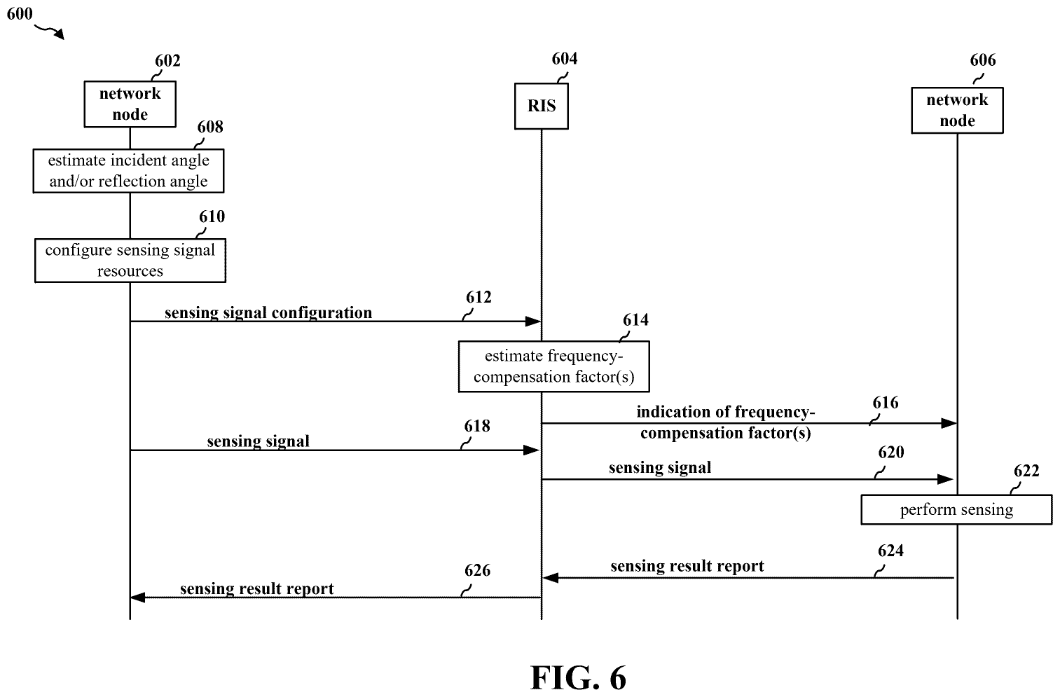

FIG. 6 is a connection flow diagram 600 illustrating an example of a RIS 604 configured to receive and forward a signal 518 from a network node 602 to a network node 606. The network node 602, RIS 604, and network node 606 may be similar to the network node 502, RIS 504, and network node 506 in FIG. 5A, respectively. At 608 the network node 602 may estimate the incident angle of the sensing signal 618 as it hits the RIS 604 and/or the reflection angle of the sensing signal 620 as it reflects off of the RIS 604. The network node 602 may estimate the incident angle and/or the reflection angle based on a location indication of the network node 602 and a location indication of the RIS 604.

At 610, the network node 602 may configure a set of sensing signal resources for the RIS 604. Each of the set of sensing signal resources may be associated with an incident angle and/or a reflection angle. The network node 602 may transmit a sensing signal configuration 612 for a set of sensing signal resources to the RIS 604. The sensing signal configuration 612 may have at least one of an incident angle or a reflection angle associated with each of the set of sensing signal resources. The set of sensing signal resources may include, for example, a set of beams or a set of sub-beams. The sensing signal configuration 612 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 612 may indicate an incident beam direction angle θᵢ to the RIS 604. In some aspects, the sensing signal configuration 612 may indicate a location of the network node 602, which the RIS 604 may use to calculate an incident beam direction angle θᵢ to the RIS 604.

At 614, the RIS 604 may estimate a set of frequency-domain compensation factors for each of the set of sensing signal resources. The RIS may transmit the indication 616 of the set of frequency-compensation factors to the network node 606. The indication 616 of the set of frequency-compensation factors may include, for example, an equivalent channel response value hₙ of each element n at the RIS 604, a reflection coefficient amplitude and phase for each frequency ψ(f), an estimated channel status value rₖ at each subcarrier k, and/or the calculated frequency-domain compensation factor gₖ(θ_{r,l}) at each subcarrier k and sensing signal resource l. The indication 616 of the set of frequency-domain compensation factors may include a set of frequency-domain compensation factors for each of the set of sensing signal resources, and a reflection beam direction angle for each of the set of sensing signal resources.

The network node 602 may transmit a sensing signal 618 to the RIS 604. The RIS 604 may reflect the sensing signal 618 as the sensing signal 620 towards the network node 606.

At 622, the network node 606 may perform sensing on the sensing signal 620 received by the network node 606. The network node 606 may perform sensing on the sensing signal 620 based on the indication 616 of the set of frequency-domain compensation factors. The network node 606 may generate a sensing result report 624, such as a report of a propagation delay for each of the set of sensing signal resources. The network node 606 may estimate attributes associated with the sensing signal 620, for example a delay at the RIS 604 or a distance between the RIS 604 and the network node 606 based on the indication 616 of the set of frequency-compensation factors. The delay value may correspond to a path of the sensing signal 620, and may be calculated by performing an IFFT based on the indication 616 of the set of frequency-domain compensation factors. The path of the sensing signal 620 may include the path of the sensing signal 618 from the network node 602 to the RIS 604 and/or the path of the sensing signal 620 from the RIS 604 to the network node 606. The network node 606 may compensate for an amplitude value or a phase value of the sensing signal 620 based on the indication 616 of the set of frequency-domain compensation factors. The sensing result report 624 may indicate, for example, an estimated distance between the RIS 604 and the network node 606, or an estimated distance between the RIS 604 and the network node 602, or an estimated value regarding the sum of the distance between the RIS 604 and the network node 606 and the distance between the RIS 604 and the network node 602.

The network node 606 may transmit the sensing result report 624 to the RIS 604. The RIS 604 may reflect the sensing result report 624 as the sensing result report 626 to the network node 602. In some aspects, the network node 606 may additionally or alternatively transmit the sensing result report 624 to another network node.

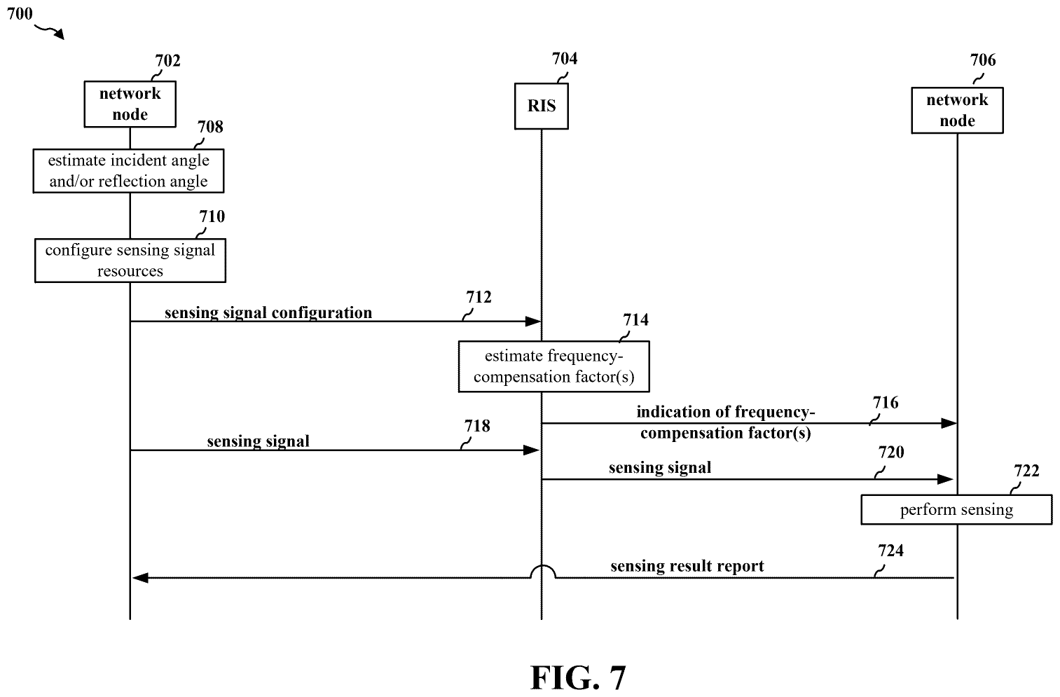

FIG. 7 is a connection flow diagram 700 illustrating an example of a RIS 704 configured to receive and forward a sensing signal 718 from a network node 702 to a network node 706. The network node 702, RIS 704, and network node 706 may be similar to the network node 502, RIS 504, and network node 506 in FIG. 5A, respectively. At 708 the network node 702 may estimate the incident angle of the sensing signal 718 as it hits the RIS 704 and/or the reflection angle of the sensing signal 720 as it reflects off of the RIS 704. The network node 702 may estimate the incident angle and/or the reflection angle based on a location indication of the network node 702 and a location indication of the RIS 704.

At 710, the network node 702 may configure a set of sensing signal resources for the RIS 704. Each of the set of sensing signal resources may be associated with an incident angle and/or a reflection angle. The network node 702 may transmit a sensing signal configuration 712 for a set of sensing signal resources to the RIS 704. The sensing signal configuration 712 may have at least one of an incident angle or a reflection angle association with each of the set of sensing signal resources. The set of sensing signal resources may include, for example, a set of beams or a set of sub-beams. The sensing signal configuration 712 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 712 may indicate an incident beam direction angle θᵢ to the RIS 704. In some aspects, the sensing signal configuration 712 may indicate a location of the network node 702, which the RIS 704 may use to calculate an incident beam direction angle θᵢ to the RIS 704.

At 714, the RIS 704 may estimate a set of frequency-domain compensation factors for each of the set of sensing signal resources. The RIS may transmit the indication 716 of the set of frequency-compensation factors to the network node 706. The indication 716 of the set of frequency-compensation factors may include, for example, an equivalent channel response value hₙ of each element n at the RIS 704, a reflection coefficient amplitude and phase for each frequency ψ(f), an estimated channel status value rₖ at each subcarrier k, and/or the calculated frequency-domain compensation factor gₖ(θ_{r,l}) at each subcarrier k and sensing signal resource l. The indication 716 of the set of frequency-domain compensation factors may include a set of frequency-domain compensation factors for each of the set of sensing signal resources, and a reflection beam direction angle for each of the set of sensing signal resources.

The network node 702 may transmit a sensing signal 718 to the RIS 704. The RIS 704 may reflect the sensing signal 718 as the sensing signal 720 towards the network node 706.

At 722, the network node 706 may perform sensing on the sensing signal 720 received by the network node 706. The network node 706 may perform sensing on the sensing signal 720 based on the indication 716 of the set of frequency-domain compensation factors. The network node 706 may generate a sensing result report 724, such as a report of a propagation delay for each of the set of sensing signal resources. The network node 706 may estimate attributes associated with the sensing signal 720, for example a delay at the RIS 704 or a distance between the RIS 704 and the network node 706 based on the indication 716 of the set of frequency-compensation factors. The delay value may correspond to a path of the sensing signal 720, and may be calculated by performing an IFFT based on the indication 716 of the set of frequency-domain compensation factors. The path of the sensing signal 720 may include the path of the sensing signal 718 from the network node 702 to the RIS 704 and/or the path of the sensing signal 720 from the RIS 704 to the network node 706. The network node 706 may compensate for an amplitude value or a phase value of the sensing signal 720 based on the indication 716 of the set of frequency-domain compensation factors. The sensing result report 724 may indicate, for example, an estimated distance between the RIS 704 and the network node 706, or an estimated distance between the RIS 704 and the network node 702, or an estimated value regarding the sum of the distance between the RIS 704 and the network node 706 and the distance between the RIS 704 and the network node 702.

The network node 706 may output the sensing result report 724 to the network node 702. The network node 706 may have a LOS path to directly transmit the sensing result report 724 from the network node 706 to the network node 702. In other words, there may not be a block, such as the signal block 508 in FIG. 5A, between the network node 702 and the network node 706. In other aspects, the network node 706 and the network node 702 may be connected via a backhaul link or a midhaul link that allow the network node 706 to directly output the sensing result report from the network node 706 to the network node 702. In some aspects, the network node 706 may additionally or alternatively transmit the sensing result report 724 to another network node.

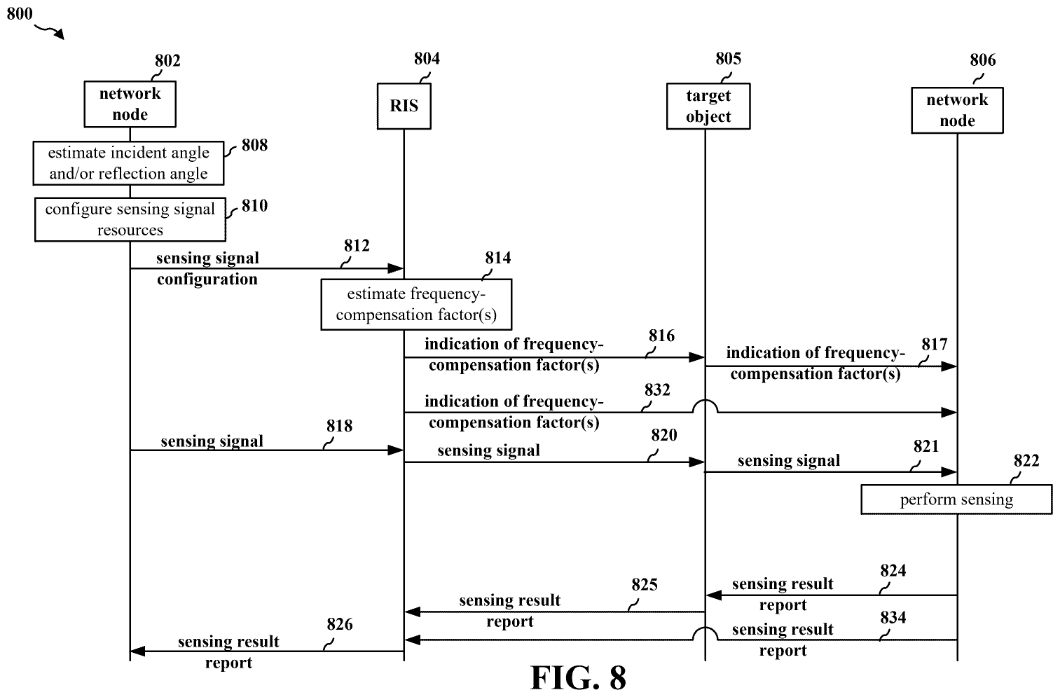

FIG. 8 is a connection flow diagram 800 illustrating an example of a RIS 804 configured to receive and forward a sensing signal 818 from a network node 802 to a network node 806 via a target object 805. The network node 802, RIS 804, target object 805, and network node 806 may be similar to the network node 502, RIS 504, target object 505, and network node 506 in FIG. 5B, respectively. At 808 the network node 802 may estimate the incident angle of the sensing signal 818 as it hits the RIS 804 and/or the reflection angle of the sensing signal 820 as it reflects off of the RIS 804. The network node 802 may estimate the incident angle and/or the reflection angle based on a location indication of the network node 802 and a location indication of the RIS 804.

At 810, the network node 802 may configure a set of sensing signal resources for the RIS 804. Each of the set of sensing signal resources may be associated with an incident angle and/or a reflection angle. The network node 802 may transmit a sensing signal configuration 812 for a set of sensing signal resources to the RIS 804. The sensing signal configuration 812 may have at least one of an incident angle or a reflection angle association with each of the set of sensing signal resources. The set of sensing signal resources may include, for example, a set of beams or a set of sub-beams. The sensing signal configuration 812 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 812 may indicate an incident beam direction angle θᵢ to the RIS 804. In some aspects, the sensing signal configuration 812 may indicate a location of the network node 802, which the RIS 804 may use to calculate an incident beam direction angle θᵢ to the RIS 804.

At 814, the RIS 804 may estimate a set of frequency-domain compensation factors for each of the set of sensing signal resources. The RIS may transmit the indication 816 of the set of frequency-compensation factors to the target object 805. The indication 816 of the set of frequency-compensation factors may include, for example, an equivalent channel response value hₙ of each element n at the RIS 804, a reflection coefficient amplitude and phase for each frequency ψ(f), an estimated channel status value rₖ at each subcarrier k, and/or the calculated frequency-domain compensation factor gₖ(θ_{r,l}) at each subcarrier k and sensing signal resource l. The indication 816 of the set of frequency-domain compensation factors may include a set of frequency-domain compensation factors for each of the set of sensing signal resources, and a reflection beam direction angle for each of the set of sensing signal resources. The target object 805 may reflect the indication 816 of the set of frequency-domain compensation factors as the indication 817 of the set of frequency-domain compensation factors to the network node 806. The target object 805 may include a UAV configured to reflect a signal from the RIS 804 to the network node 806. The target object 805 may also be configured to reflect a signal from the network node 806 to the RIS 804. In some aspects, the RIS 804 may transmit the indication 832 of the set of frequency-domain compensation factors directly to the network node 806 instead of, or in addition to, transmitting the indication 816 of the set of frequency-compensation factors to the target object 805.

The network node 802 may transmit a sensing signal 818 to the RIS 804. The RIS 804 may reflect the sensing signal 818 as the sensing signal 820 towards the target object 805. The target object 805 may reflect the sensing signal 820 as the sensing signal 821 towards the network node 806.

At 822, the network node 806 may perform sensing on the sensing signal 821 received by the network node 806. The network node 806 may perform sensing on the sensing signal 821 based on the indication 817 of the set of frequency-domain compensation factors. The network node 806 may generate a sensing result report 824, such as a report of a propagation delay for each of the set of sensing signal resources and/or of a distance to the target object 805. The network node 806 may estimate attributes associated with the sensing signal 821, for example a delay at the RIS 804 or a distance between the RIS 804 and the target object 805 based on the indication 817 of the set of frequency-compensation factors. The delay value may correspond to a path of the sensing signal 821, and may be calculated by performing an IFFT based on the indication 817 of the set of frequency-domain compensation factors. The path of the sensing signal 821 may include the path of the sensing signal 818 from the network node 802 to the RIS 804, the path of the sensing signal 820 from the RIS 804 to the target object 805, and/or the path of the sensing signal 821 from the target object 805 to the network node 806. The network node 806 may compensate for an amplitude value or a phase value of the sensing signal 821 based on the indication 817 of the set of frequency-domain compensation factors. The sensing result report 824 may indicate, for example, an estimated distance between the RIS 804 and the target object 805, an estimated distance between the target object 805 and the network node 806, or an estimated distance between the RIS 804 and the network node 802, or an estimated value regarding the sum of the distance between the network node 802 and the RIS 804, the distance between the RIS 804 and the target object 805, and the distance between the target object 805 and the network node 806.

The network node 806 may transmit the sensing result report 824 to the target object 805. The target object 805 may reflect the sensing result report 824 as the sensing result report 825 to the RIS 804. The RIS 804 may reflect the sensing result report 825 as the sensing result report 826 to the network node 802. In some aspects, the network node 806 may additionally or alternatively transmit the sensing result report 824 to another wireless device. For example, the network node 806 may transmit the sensing result report 834 directly to the RIS 804 instead of, or in addition to, transmitting the sensing result report 824 to the target object 805. In another example, the network node 806 may transmit a sensing result report to another network node, which may process the sensing result report, or forward the sensing result report to the network node 802.

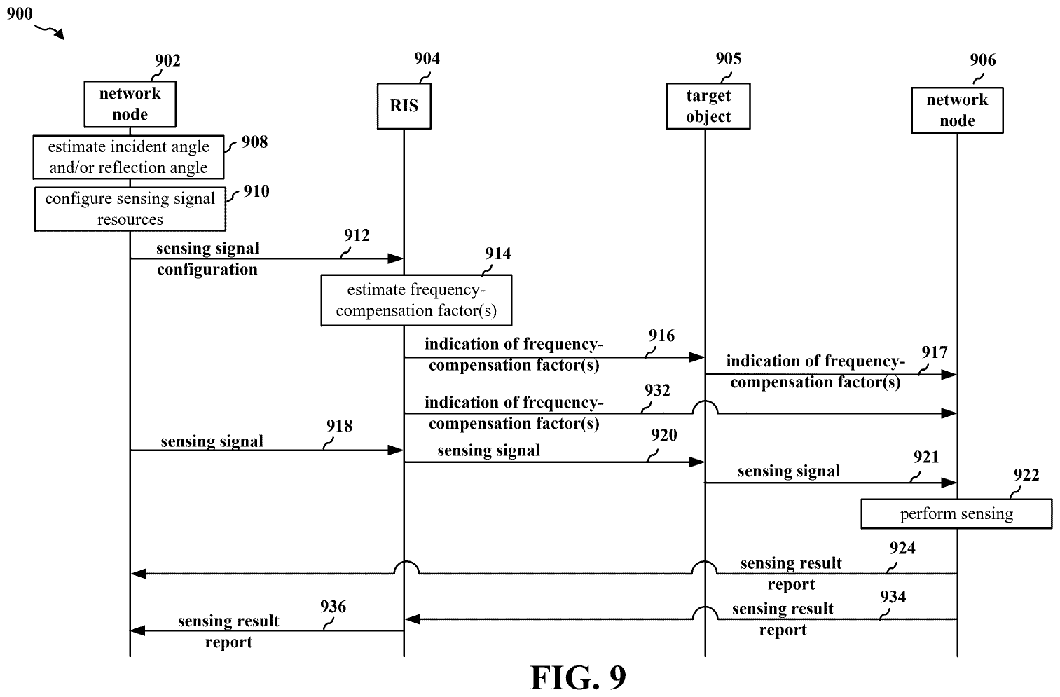

FIG. 9 is a connection flow diagram 900 illustrating an example of a RIS 904 configured to receive and forward a sensing signal 918 from a network node 902 to a network node 906 via a target object 905. The network node 902, RIS 904, target object 905, and network node 906 may be similar to the network node 502, RIS 504, target object 505, and network node 506 in FIG. 5B, respectively. At 908 the network node 902 may estimate the incident angle of the sensing signal 918 as it hits the RIS 904 and/or the reflection angle of the sensing signal 920 as it reflects off of the RIS 904. The network node 902 may estimate the incident angle and/or the reflection angle based on a location indication of the network node 902 and a location indication of the RIS 904.

At 910, the network node 902 may configure a set of sensing signal resources for the RIS 904. Each of the set of sensing signal resources may be associated with an incident angle and/or a reflection angle. The network node 902 may transmit a sensing signal configuration 912 for a set of sensing signal resources to the RIS 904. The sensing signal configuration 912 may have at least one of an incident angle or a reflection angle association with each of the set of sensing signal resources. The set of sensing signal resources may include, for example, a set of beams or a set of sub-beams. The sensing signal configuration 912 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 912 may indicate an incident beam direction angle θ; to the RIS 904. In some aspects, the sensing signal configuration 912 may indicate a location of the network node 902, which the RIS 904 may use to calculate an incident beam direction angle θ; to the RIS 904.

At 914, the RIS 904 may estimate a set of frequency-domain compensation factors for each of the set of sensing signal resources. The RIS may transmit the indication 916 of the set of frequency-compensation factors to the target object 905. The indication 916 of the set of frequency-compensation factors may include, for example, an equivalent channel response value hₙ of each element n at the RIS 904, a reflection coefficient amplitude and phase for each frequency ψ(f), an estimated channel status value rₖ at each subcarrier k, and/or the calculated frequency-domain compensation factor gₖ(θ_{r,l}) at each subcarrier k and sensing signal resource l. The indication 916 of the set of frequency-domain compensation factors may include a set of frequency-domain compensation factors for each of the set of sensing signal resources, and a reflection beam direction angle for each of the set of sensing signal resources. The target object 905 may reflect the indication 916 of the set of frequency-domain compensation factors as the indication 917 of the set of frequency-domain compensation factors to the network node 906. The target object 905 may include a UAV configured to reflect a signal from the RIS 904 to the network node 906. The target object 905 may also be configured to reflect a signal from the network node 906 to the RIS 904. In some aspects, the RIS 904 may transmit the indication 932 of the set of frequency-domain compensation factors directly to the network node 906 instead of, or in addition to, transmitting the indication 916 of the set of frequency-compensation factors to the target object 905.

The network node 902 may transmit a sensing signal 918 to the RIS 904. The RIS 904 may reflect the sensing signal 918 as the sensing signal 920 towards the target object 905. The target object 905 may reflect the sensing signal 920 as the sensing signal 921 towards the network node 906.

At 922, the network node 906 may perform sensing on the sensing signal 921 received by the network node 906. The network node 906 may perform sensing on the sensing signal 921 based on the indication 917 of the set of frequency-domain compensation factors. The network node 906 may generate a sensing result report 924, such as a report of a propagation delay for each of the set of sensing signal resources and/or of a distance to the target object 905. The network node 906 may estimate attributes associated with the sensing signal 921, for example a delay at the RIS 904 or a distance between the RIS 904 and the target object 905 based on the indication 917 of the set of frequency-compensation factors. The delay value may correspond to a path of the sensing signal 921, and may be calculated by performing an IFFT based on the indication 917 of the set of frequency-domain compensation factors. The path of the sensing signal 921 may include the path of the sensing signal 918 from the network node 902 to the RIS 904, the path of the sensing signal 920 from the RIS 904 to the target object 905, and/or the path of the sensing signal 921 from the target object 905 to the network node 906. The network node 906 may compensate for an amplitude value or a phase value of the sensing signal 921 based on the indication 917 of the set of frequency-domain compensation factors. The sensing result report 924 may indicate, for example, an estimated distance between the RIS 904 and the target object 905, or an estimated distance between the target object 905 and the network node 906, or an estimated distance between the RIS 904 and the network node 902, or an estimated value regarding the sum of the distance between the network node 902 and the RIS 904, the distance between the RIS 904 and the target object 905, and the distance between the target object 905 and the network node 906.

The network node 906 may output the sensing result report 924 to the network node 902. The network node 906 may have a LOS path to directly transmit the sensing result report 924 from the network node 906 to the network node 902. In other words, there may not be a block, such as the signal block 508 in FIG. 5B, between the network node 902 and the network node 906. In other aspects, the network node 906 and the network node 902 may be connected via a backhaul link or a midhaul link that allow the network node 906 to directly output the sensing result report from the network node 906 to the network node 902. In some aspects, the network node 906 may additionally or alternatively transmit the sensing result report 924 to another wireless device. For example, the network node 906 may transmit the sensing result report 934 to the RIS 904 instead of, or in addition to, transmitting the sensing result report 924 to the network node 902. The RIS 904 may reflect the sensing result report 934 as the sensing result report 936 to the network node 902. In another example, the network node 906 may transmit a sensing result report to another network node, which may process the sensing result report, or forward the sensing result report to the network node 902.

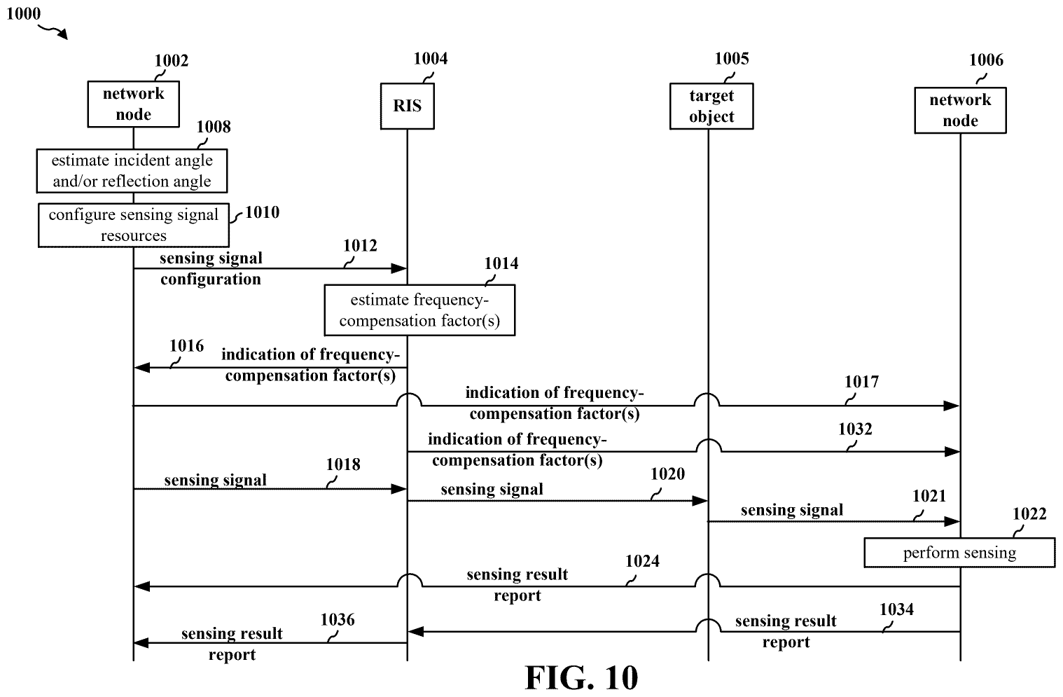

FIG. 10 is an alternative connection flow diagram 1000 illustrating an example of a RIS 1004 configured to receive and forward a sensing signal 1018 from a network node 1002 to a network node 1006 via a target object 1005. The network node 1002, RIS 1004, target object 1005, and network node 1006 may be similar to the network node 902, RIS 904, target object 905, and network node 906 in FIG. 9, respectively. At 1008 the network node 1002 may estimate the incident angle of the sensing signal 1018 as it hits the RIS 1004 and/or the reflection angle of the sensing signal 1020 as it reflects off of the RIS 1004. The network node 1002 may estimate the incident angle and/or the reflection angle based on a location indication of the network node 1002 and a location indication of the RIS 1004.

At 1010, the network node 1002 may configure a set of sensing signal resources for the RIS 1004. Each of the set of sensing signal resources may be associated with an incident angle and/or a reflection angle. The network node 1002 may transmit a sensing signal configuration 1012 for a set of sensing signal resources to the RIS 1004. The sensing signal configuration 1012 may have at least one of an incident angle or a reflection angle association with each of the set of sensing signal resources. The set of sensing signal resources may include, for example, a set of beams or a set of sub-beams. The sensing signal configuration 1012 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 1012 may indicate an incident beam direction angle θᵢ to the RIS 1004. In some aspects, the sensing signal configuration 1012 may indicate a location of the network node 1002, which the RIS 1004 may use to calculate an incident beam direction angle θᵢ to the RIS 1004.

At 1014, the RIS 1004 may estimate a set of frequency-domain compensation factors for each of the set of sensing signal resources. The indication 1016 of the set of frequency-compensation factors may include, for example, an equivalent channel response value hₙ of each element n at the RIS 604, a reflection coefficient amplitude and phase for each frequency ψ(f), an estimated channel status value rₓ at each subcarrier k, and/or the calculated frequency-domain compensation factor gₖ(θ_{r,l}) at each subcarrier k and sensing signal resource l. The indication 1016 of the set of frequency-domain compensation factors may include a set of frequency-domain compensation factors for each of the set of sensing signal resources, and a reflection beam direction angle for each of the set of sensing signal resources. The RIS may transmit the indication 1016 of the set of frequency-compensation factors to the network node 1002. Since the network node 1002 may directly communicate with the network node 1006 (e.g., via a LOS wireless path or a backhaul/midhaul wired path), the network node 1002 may output the indication 1016 of the set of frequency-compensation factors as the indication 1017 of the set of frequency-compensation factors to the network node 1006. In some aspects, the RIS 1004 may additionally or alternatively transmit the indication 1032 of the set of frequency-compensation factors to the network node 1006. The network node 1006 may receive the indication 1017 of the set of frequency-compensation factors from the network node 1002 and/or the indication 1032 of the set of frequency-compensation factors from the RIS 1004.

The network node 1002 may transmit a sensing signal 1018 to the RIS 1004. The RIS 1004 may reflect the sensing signal 1018 as the sensing signal 1020 towards the target object 1005. The target object 1005 may reflect the sensing signal 1020 as the sensing signal 1021 towards the network node 1006.

At 1022, the network node 1006 may perform sensing on the sensing signal 1021 received by the network node 1006. The network node 1006 may perform sensing on the sensing signal 1021 based on the indication 1017 of the set of frequency-domain compensation factors. The network node 1006 may generate a sensing result report 1024, such as a report of a propagation delay for each of the set of sensing signal resources and/or of a distance to the target object 1005. The network node 1006 may estimate attributes associated with the sensing signal 1021, for example a delay at the RIS 1004 or a distance between the RIS 1004 and the target object 1005 based on the indication 1017 of the set of frequency-compensation factors. The delay value may correspond to a path of the sensing signal 1021, and may be calculated by performing an IFFT based on the indication 1017 of the set of frequency-domain compensation factors. The path of the sensing signal 1021 may include the path of the sensing signal 1018 from the network node 1002 to the RIS 1004, the path of the sensing signal 1020 from the RIS 1004 to the target object 1005, and/or the path of the sensing signal 1021 from the target object 1005 to the network node 1006. The network node 1006 may compensate for an amplitude value or a phase value of the sensing signal 1021 based on the indication 1017 of the set of frequency-domain compensation factors. The sensing result report 1024 may indicate, for example, an estimated distance between the RIS 1004 and the target object 1005, or an estimated distance between the target object 1005 and the network node 1006, or an estimated distance between the RIS 1004 and the network node 1002, or an estimated value regarding the sum of the distance between the network node 1002 and the RIS 1004, the distance between the RIS 1004 and the target object 1005, and the distance between the target object 1005 and the network node 1006.

The network node 1006 may output the sensing result report 1024 to the network node 1002. In some aspects, the network node 1006 may additionally or alternatively transmit the sensing result report 1024 to another wireless device. For example, the network node 1006 may transmit the sensing result report 1034 to the RIS 1004 instead of, or in addition to, transmitting the sensing result report 1024 to the network node 1002. The RIS 1004 may reflect the sensing result report 1034 as the sensing result report 1036 to the network node 1002. In another example, the network node 1006 may transmit a sensing result report to another network node, which may process the sensing result report, or forward the sensing result report to the network node 1002.

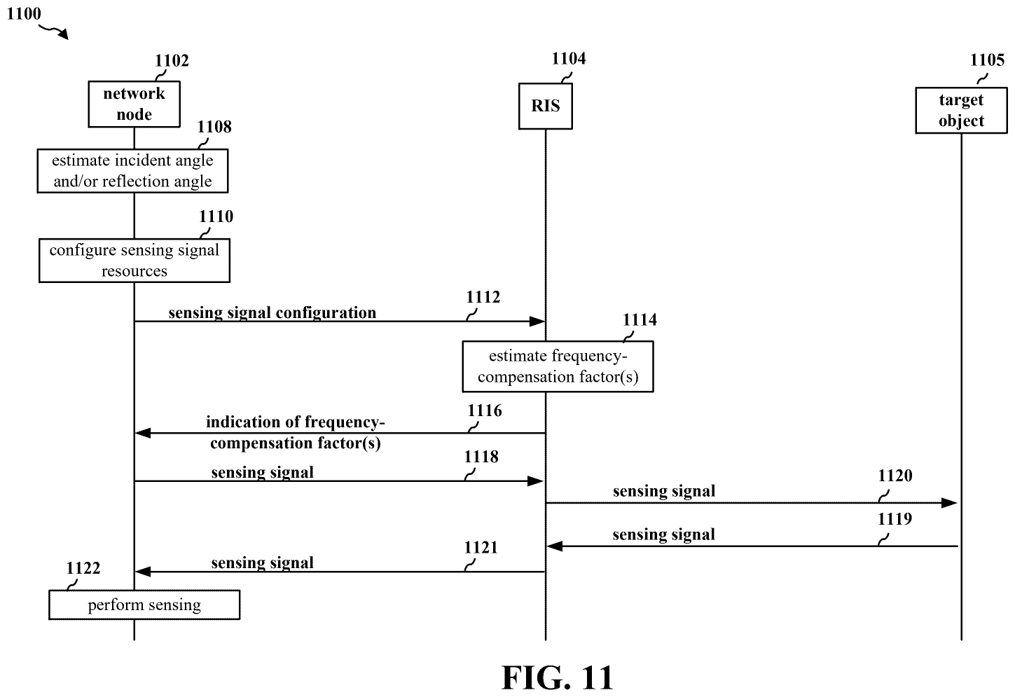

FIG. 11 is a connection flow diagram 1100 illustrating an example of a RIS 1104 configured to receive and forward a sensing signal 1118 from a network node 1102 back to the network node 1102 via a target object 1105. The network node 1102, RIS 1104, and target object 1105 may be similar to the network node 502, RIS 504, and target object 505 in FIG. 5C, respectively. At 1108 the network node 1102 may estimate the incident angle of the sensing signal 1118 as it hits the RIS 1104 and/or the reflection angle of the sensing signal 1120 as it reflects off of the RIS 1104. The network node 1102 may estimate the incident angle and/or the reflection angle based on a location indication of the network node 1102 and a location indication of the RIS 1104.

At 1110, the network node 1102 may configure a set of sensing signal resources for the RIS 1104. Each of the set of sensing signal resources may be associated with an incident angle and/or a reflection angle. The network node 1102 may transmit a sensing signal configuration 1112 for a set of sensing signal resources to the RIS 1104. The sensing signal configuration 1112 may have at least one of an incident angle or a reflection angle association with each of the set of sensing signal resources. The set of sensing signal resources may include, for example, a set of beams or a set of sub-beams. The sensing signal configuration 1112 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 1112 may indicate an incident beam direction angle θ; to the RIS 1104. In some aspects, the sensing signal configuration 1112 may indicate a location of the network node 1102, which the RIS 1104 may use to calculate an incident beam direction angle θ; to the RIS 1104.

At 1114, the RIS 1104 may estimate a set of frequency-domain compensation factors for each of the set of sensing signal resources. The RIS 1104 may estimate at least one of the set of frequency-domain compensation factors as a product of a first frequency-domain compensation factor of an DL reflection (e.g., the DL reflection with sensing signal 1118 as incident signal and with sensing signal 1120 as reflective signal) and a second frequency-domain compensation factor of a UL reflection (e.g., the UL reflection with sensing signal 1119 as incident signal and with sensing signal 1121 as reflective signal). The RIS may transmit the indication 1116 of the set of frequency-compensation factors to the network node 1102. The indication 1116 of the set of frequency-compensation factors may include, for example, an equivalent channel response value hₙ of each element n at the RIS 1104, a reflection coefficient amplitude and phase for each frequency ψ(f), an estimated channel status value rₖ at each subcarrier k, and/or the calculated frequency-domain compensation factor gₖ(θ_{r,l}) at each subcarrier k and sensing signal resource l. The indication 1116 of the set of frequency-domain compensation factors may include a set of frequency-domain compensation factors for each of the set of sensing signal resources, and a reflection beam direction angle for each of the set of sensing signal resources.

The network node 1102 may transmit a sensing signal 1118 to the RIS 1104. The RIS 1104 may reflect the sensing signal 1118 as the sensing signal 1120 towards the target object 1105. The target object 1105 may include a UAV configured to reflect a signal from a first portion of the RIS 1104 to a second portion of the RIS 1104. The target object 1105 may also be configured to reflect a signal from a third portion of the RIS 1104 to a fourth portion of the RIS 1104, providing for bi-directional reflectional communication. The target object 1105 may reflect the sensing signal 1120 as the sensing signal 1119 back towards the RIS 1104. The RIS 1104 may reflect the sensing signal 1119 as the sensing signal 1121 back towards the network node 1102.

At 1122, the network node 1102 may perform sensing on the sensing signal 1121 received by the RIS 1104. The network node 1102 may perform sensing on the sensing signal 1121 based on the indication 1116 of the set of frequency-domain compensation factors. The network node 1102 may generate a sensing result report, such as a report of a propagation delay for each of the set of sensing signal resources and/or of a distance to the target object 1105. The network node 1102 may estimate attributes associated with the sensing signal 1121, for example a delay at the RIS 1104 or a distance between the RIS 1104 and the target object 1105 based on the indication 1116 of the set of frequency-compensation factors. The delay value may correspond to a path of the sensing signal 1121, and may be calculated by performing an IFFT based on the indication 1116 of the set of frequency-domain compensation factors. The path of the sensing signal 1121 may include the path of the sensing signal 1118 from the network node 1102 to the RIS 1104, the path of the sensing signal 1120 from the RIS 1104 to the target object 1105, the path of the sensing signal 1119 from the target object 1105 to the RIS 1104, and/or the path of the sensing signal 1121 from the RIS 1104 to the network node 1102. The network node 1102 may compensate for an amplitude value or a phase value of the sensing signal 1121 based on the indication 1116 of the set of frequency-domain compensation factors. The sensing result report may indicate, for example, an estimated distance between the RIS 1104 and the target object 1105, or an estimated distance between the RIS 1104 and the network node 1102, or an estimated value regarding the sum of the distance between the network node 1102 and the RIS 1104, the distance between the RIS 1104 and the target object 1105, the distance between the target object 1105 and the RIS 1104, and the distance between the RIS 1104 and the network node 1102.

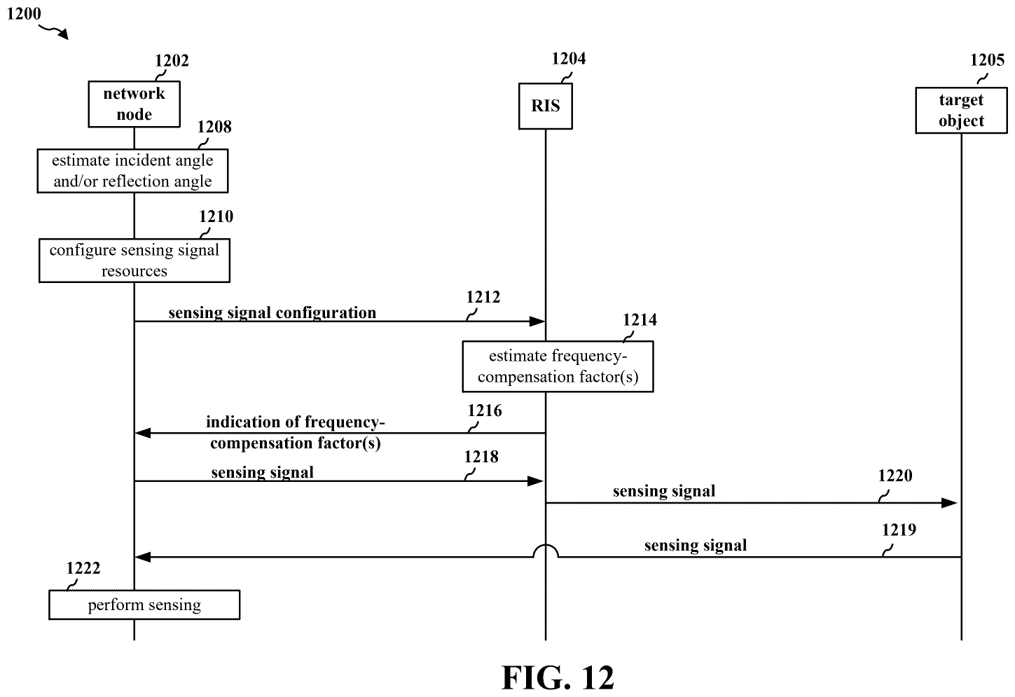

FIG. 12 is a connection flow diagram 1200 illustrating an example of a RIS 1204 configured to receive and forward a sensing signal 1218 from a network node 1202 to a target object 1205, which forwards the sensing signal back to the network node 1202. The network node 1202, RIS 1204, and target object 1205 may be similar to the network node 502, RIS 504, and target object 505 in FIG. 5C, respectively. At 1208 the network node 1202 may estimate the incident angle of the sensing signal 1218 as it hits the RIS 1204 and/or the reflection angle of the sensing signal 1220 as it reflects off of the RIS 1204. The network node 1202 may estimate the incident angle and/or the reflection angle based on a location indication of the network node 1202 and a location indication of the RIS 1204.

At 1210, the network node 1202 may configure a set of sensing signal resources for the RIS 1204. Each of the set of sensing signal resources may be associated with an incident angle and/or a reflection angle. The network node 1202 may transmit a sensing signal configuration 1212 for a set of sensing signal resources to the RIS 1204. The sensing signal configuration 1212 may have at least one of an incident angle or a reflection angle association with each of the set of sensing signal resources. The set of sensing signal resources may include, for example, a set of beams or a set of sub-beams. The sensing signal configuration 1212 may indicate at least one of a set of incident beam direction angles, a range of incident beam direction angles, a set of reflection beam angles, a range of reflection beam angles, a set of incident beam direction angles associated with a set of reflection beam angles, or a range of incident beam angles associated with a range of reflection beam angles for each of the set of sensing signal resources. In some aspects, the sensing signal configuration 1212 may indicate an incident beam direction angle θᵢ to the RIS 1204. In some aspects, the sensing signal configuration 1212 may indicate a location of the network node 1202, which the RIS 1204 may use to calculate an incident beam direction angle θᵢ to the RIS 1204.

At 1214, the RIS 1204 may estimate a set of frequency-domain compensation factors for each of the set of sensing signal resources. The RIS may transmit the indication 1216 of the set of frequency-compensation factors to the network node 1202. The indication 1216 of the set of frequency-compensation factors may include, for example, an equivalent channel response value hₙ of each element n at the RIS 1204, a reflection coefficient amplitude and phase for each frequency ψ(f), an estimated channel status value rₖ at each subcarrier k, and/or the calculated frequency-domain compensation factor gₖ(θ_{r,l}) at each subcarrier k and sensing signal resource l. The indication 1216 of the set of frequency-domain compensation factors may include a set of frequency-domain compensation factors for each of the set of sensing signal resources, and a reflection beam direction angle for each of the set of sensing signal resources.

The network node 1202 may transmit a sensing signal 1218 to the RIS 1204. The RIS 1204 may reflect the sensing signal 1218 as the sensing signal 1220 towards the target object 1205. The target object 1205 may include a UAV configured to reflect a signal from a first portion of the RIS 1204 to a second portion of the RIS 1204. The target object 1205 may also be configured to reflect a signal from a third portion of the RIS 1204 back to the network node 1202. The target object 1205 may reflect the sensing signal 1220 as the sensing signal 1219 back towards the network node 1202.

At 1222, the network node 1202 may perform sensing on the sensing signal 1219 from the target object 1205. The network node 1202 may perform sensing on the sensing signal 1219 based on the indication 1216 of the set of frequency-domain compensation factors. The network node 1202 may generate a sensing result report, such as a report of a propagation delay for each of the set of sensing signal resources and/or of a distance to the target object 1205. The network node 1202 may estimate attributes associated with the sensing signal 1219, for example a delay at the RIS 1204 or a distance between the RIS 1204 and the target object 1205 based on the indication 1216 of the set of frequency-compensation factors. The delay value may correspond to a path of the sensing signal 1219, and may be calculated by performing an IFFT based on the indication 1216 of the set of frequency-domain compensation factors. The path of the sensing signal 1219 may include the path of the sensing signal 1218 from the network node 1202 to the RIS 1204, the path of the sensing signal 1220 from the RIS 1204 to the target object 1205, and/or the path of the sensing signal 1219 from the target object 1205 to the network node 1202. The network node 1202 may compensate for an amplitude value or a phase value of the sensing signal 1219 based on the indication 1216 of the set of frequency-domain compensation factors. The sensing result report may indicate, for example, an estimated distance between the RIS 1204 and the target object 1205, or an estimated distance between the RIS 1204 and the network node 1202, or an estimated value regarding the sum of the distance between the network node 1202 and the RIS 1204, the distance between the RIS 1204 and the target object 1205, the distance between the target object 1205 and the RIS 1204, and the distance between the RIS 1204 and the network node 1202.

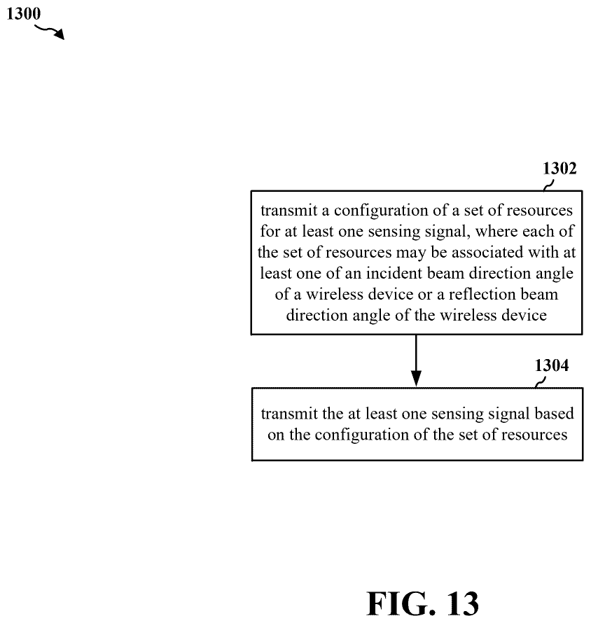

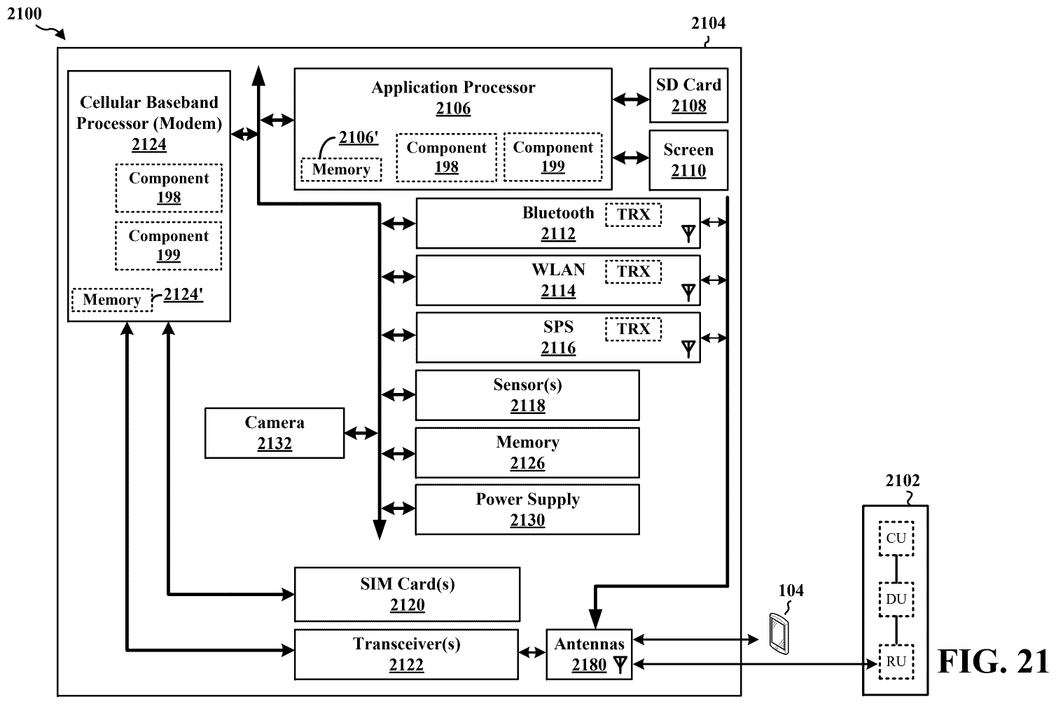

FIG. 13 is a flowchart 1300 of a method of wireless communication. The method may be performed by a first network node (e.g., the UE 104, the UE 350; the base station 102, the base station 310; the network node 402, the network node 502, the network node 602, the network node 702, the network node 802, the network node 902, the network node 1002, the network node 1102, the network node 1202; the network entity 2102, the network entity 2202, the network entity 2360). At 1302, the first network node may transmit a configuration of a set of resources for at least one sensing signal. Each of the set of resources may be associated with at least one of an incident beam direction angle of a wireless device or a reflection beam direction angle of the wireless device. For example, 1302 may be performed by the network node 802 in FIG. 8, which may transmit the sensing signal configuration 812 of a set of resources for the sensing signal 818. Each of the set of resources configured by the sensing signal configuration 812 may be associated with at least one of an incident beam direction angle of the RIS 804 or a reflection beam direction angle of the RIS 804. Moreover, 1302 may be performed by the component 198 in FIGS. 21-23.

At 1304, the first network node may transmit the at least one sensing signal based on the configuration of the set of resources. For example, 1304 may be performed by the network node 802 in FIG. 8, which may transmit the sensing signal 818 based on the sensing signal configuration 812 of the set of resources. Moreover, 1304 may be performed by the component 198 in FIGS. 21-23.

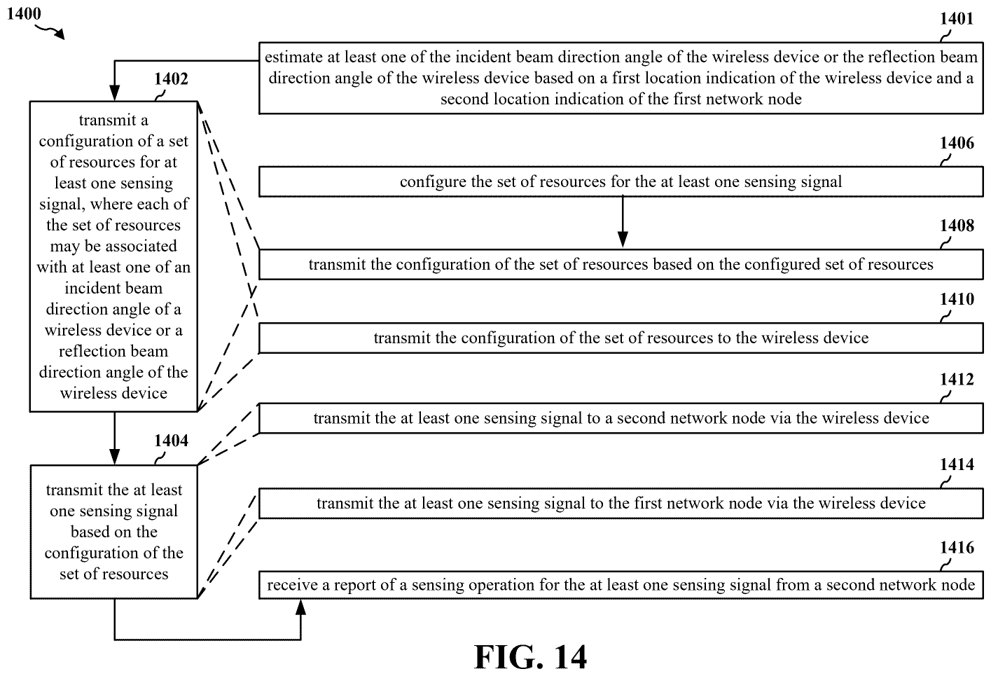

FIG. 14 is a flowchart 1400 of a method of wireless communication. The method may be performed by a first network node (e.g., the UE 104, the UE 350; the base station 102, the base station 310; the network node 402, the network node 502, the network node 602, the network node 702, the network node 802, the network node 902, the network node 1002, the network node 1102, the network node 1202; the network entity 2102, the network entity 2202, the network entity 2360).

At 1401, the first network node may estimate at least one of the incident beam direction angle of the wireless device or the reflection beam direction angle of the wireless device based on a first location indication of the wireless device and a second location indication of the first network node. For example, 1401 may be performed by the network node 802 in FIG. 8, which may, at 808, estimate at least one of the incident beam direction angle of the RIS 804 or the reflection beam direction angle of the RIS 804 based on a first location indication of the RIS 804 and a second location indication of the network node 802. Moreover, 1401 may be performed by the component 198 in FIGS. 21-23.

At 1402, the first network node may transmit a configuration of a set of resources for at least one sensing signal. Each of the set of resources may be associated with at least one of an incident beam direction angle of a wireless device or a reflection beam direction angle of the wireless device. For example, 1402 may be performed by the network node 802 in FIG. 8, which may transmit the sensing signal configuration 812 of a set of resources for the sensing signal 818. Each of the set of resources configured by the sensing signal configuration 812 may be associated with at least one of an incident beam direction angle of the RIS 804 or a reflection beam direction angle of the RIS 804. Moreover, 1402 may be performed by the component 198 in FIGS. 21-23.

At 1404, the first network node may transmit the at least one sensing signal based on the configuration of the set of resources. For example, 1404 may be performed by the network node 802 in FIG. 8, which may transmit the sensing signal 818 based on the sensing signal configuration 812 of the set of resources. Moreover, 1404 may be performed by the component 198 in FIGS. 21-23.

At 1406, the first network node may configure the set of resources for the at least one sensing signal. For example, 1406 may be performed by the network node 802 in FIG. 8, which may configure the set of resources for the sensing signal 818. Moreover, 1406 may be performed by the component 198 in FIGS. 21-23.

At 1408, the first network node may transmit the configuration of the set of resources based on the configured set of resources. For example, 1406 may be performed by the network node 802 in FIG. 8, which may transmit the sensing signal configuration 812 of the set of resources based on the configured set of resources. Moreover, 1406 may be performed by the component 198 in FIGS. 21-23.

At 1410, the first network node may transmit the configuration of the set of resources to the wireless device. For example, 1410 may be performed by the network node 802 in FIG. 8, which may transmit the sensing signal configuration 812 of the set of resources to the RIS 804. Moreover, 1410 may be performed by the component 198 in FIGS. 21-23.

At 1412, the first network node may transmit the at least one sensing signal to a second network node via the wireless device. For example, 1412 may be performed by the network node 802 in FIG. 8, which may transmit the sensing signal 818 to the network node 806 via the RIS 804. Moreover, 1412 may be performed by the component 198 in FIGS. 21-23.

At 1414, the first network node may transmit the at least one sensing signal to the first network node via the wireless device. For example, 1414 may be performed by the network node 1102 in FIG. 11, which may transmit the sensing signal 1118 to the network node 1102 via the RIS 1104. Moreover, 1414 may be performed by the component 198 in FIGS. 21-23.

At 1416, the first network node may receive a report of a sensing operation for the at least one sensing signal from a second network node. For example, 1416 may be performed by the network node 802 in FIG. 8, which may receive the sensing result report 826 of the sensing operation at 822 for the sensing signal 818 from the network node 806. Moreover, 1416 may be performed by the component 198 in FIGS. 21-23.

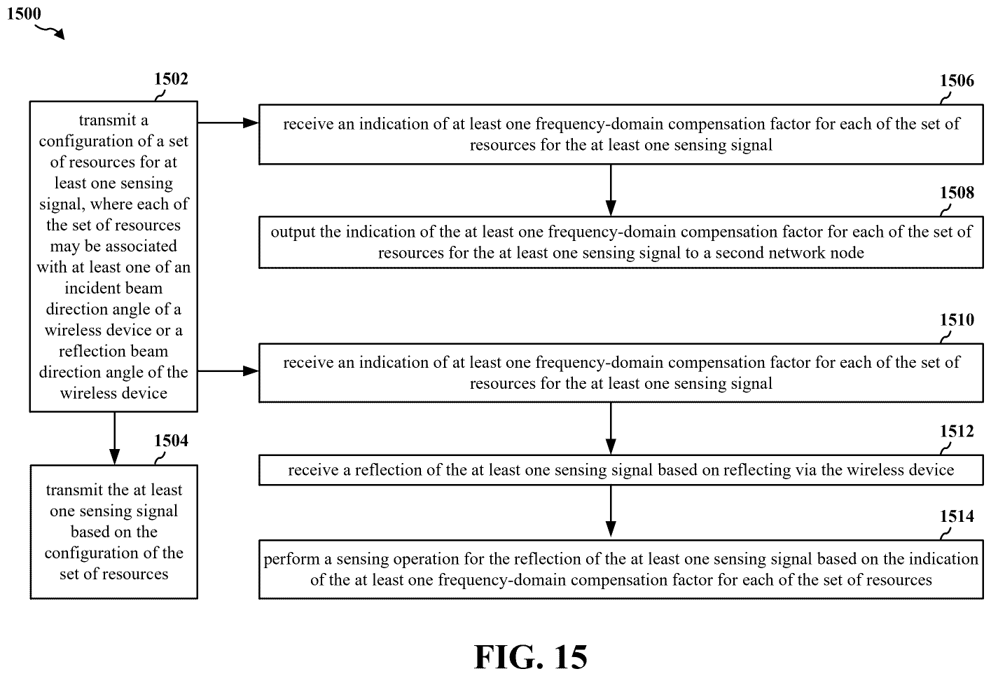

FIG. 15 is a flowchart 1500 of a method of wireless communication. The method may be performed by a first network node (e.g., the UE 104, the UE 350; the base station 102, the base station 310; the network node 402, the network node 502, the network node 602, the network node 702, the network node 802, the network node 902, the network node 1002, the network node 1102, the network node 1202; the network entity 2102, the network entity 2202, the network entity 2360). At 1502, the first network node may transmit a configuration of a set of resources for at least one sensing signal. Each of the set of resources may be associated with at least one of an incident beam direction angle of a wireless device or a reflection beam direction angle of the wireless device. For example, 1502 may be performed by the network node 802 in FIG. 8, which may transmit the sensing signal configuration 812 of a set of resources for the sensing signal 818. Each of the set of resources configured by the sensing signal configuration 812 may be associated with at least one of an incident beam direction angle of the RIS 804 or a reflection beam direction angle of the RIS 804. Moreover, 1502 may be performed by the component 198 in FIGS. 21-23.

At 1504, the first network node may transmit the at least one sensing signal based on the configuration of the set of resources. For example, 1504 may be performed by the network node 802 in FIG. 8, which may transmit the sensing signal 818 based on the sensing signal configuration 812 of the set of resources. Moreover, 1504 may be performed by the component 198 in FIGS. 21-23.

At 1506, the first network node may receive an indication of at least one frequency-domain compensation factor for each of the set of resources for the at least one sensing signal. For example, 1506 may be performed by the network node 1002 in FIG. 10, which may receive the indication 1016 of the set of frequency-domain compensation factors for each of the set of resources for the sensing signal 1018. Moreover, 1506 may be performed by the component 198 in FIGS. 21-23.

At 1508, the first network node may output the indication of the at least one frequency-domain compensation factor for each of the set of resources for the at least one sensing signal to a second network node. For example, 1506 may be performed by the network node 1002 in FIG. 10, which may output the indication 1017 of the set of frequency-compensation factors to for each of the set of resources for the sensing signal 1018 to the network node 1006. Moreover, 1506 may be performed by the component 198 in FIGS. 21-23.

At 1510, the first network node may receive an indication of at least one frequency-domain compensation factor for each of the set of resources for the at least one sensing signal. For example, 1510 may be performed by the network node 1002 in FIG. 10, which may receive the indication 1016 of the set of frequency-compensation factors for each of the set of resources for the sensing signal 1018. Moreover, 1510 may be performed by the component 198 in FIGS. 21-23.

At 1512, the first network node may receive a reflection of the at least one sensing signal based on reflecting via the wireless device. For example, 1512 may be performed by the network node 1102 in FIG. 11, which may receive a reflection as the sensing signal 1121 of the sensing signal 1118 based on reflecting via the RIS 1104. Moreover, 1512 may be performed by the component 198 in FIGS. 21-23.

At 1514, the first network node may perform a sensing operation for the reflection of the at least one sensing signal based on the indication of the at least one frequency-domain compensation factor for each of the set of resources. For example, 1514 may be performed by the network node 802 in FIG. 8, which may perform, at 1122 a sensing operation for the sensing signal 1121, which may be a reflection of the sensing signal 1118 based on the indication 1116 of the set of frequency-compensation factors for each of the set of resources. Moreover, 1514 may be performed by the component 198 in FIGS. 21-23.

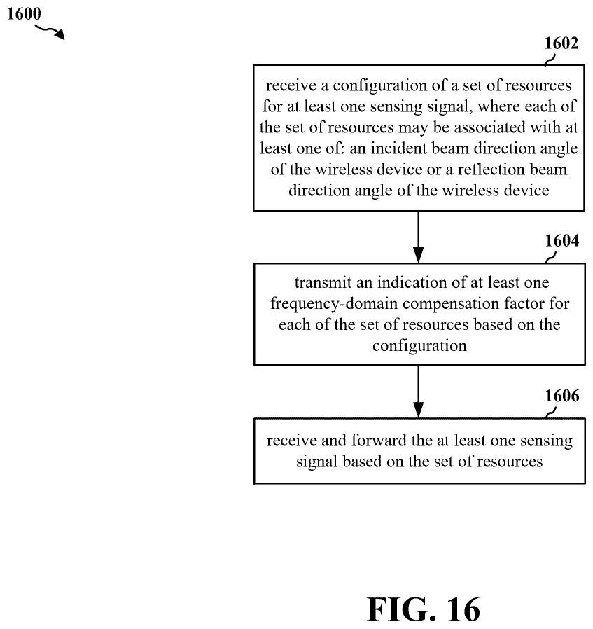

FIG. 16 is a flowchart 1600 of a method of wireless communication. The method may be performed by a wireless device (e.g., the RIS 106, the RIS 404, the RIS 504, the RIS 604, the RIS 704, the RIS 804, the RIS 904, the RIS 1004, the RIS 1104, the RIS 1204). At 1602, the wireless device may receive a configuration of a set of resources for at least one sensing signal. Each of the set of resources may be associated with at least one of: an incident beam direction angle of the wireless device or a reflection beam direction angle of the wireless device. For example, 1602 may be performed by the RIS 804 in FIG. 8, which may receive the sensing signal configuration 812 of a set of resources for the sensing signal 818. Each of the set of resources configured by the sensing signal configuration 812 may be associated with at least one of an incident beam direction angle of the RIS 804 or a reflection beam direction angle of the RIS 804. Moreover, 1602 may be performed by the component 197 in FIG. 4.

At 1604, the wireless device may transmit an indication of at least one frequency-domain compensation factor for each of the set of resources based on the configuration. For example, 1604 may be performed by the RIS 804 in FIG. 8, which may transmit an indication 816 of the set of frequency-compensation factors for each of the set of resources based on the sensing signal configuration 812. Moreover, 1604 may be performed by the component 197 in FIG. 4.

At 1606, the wireless device may receive and forward the at least one sensing signal based on the set of resources. For example, 1606 may be performed by the RIS 804 in FIG. 8, which may receive and forward the sensing signal 818 based on the set of resources configured by the sensing signal configuration 812. Moreover, 1606 may be performed by the component 197 in FIG. 4.

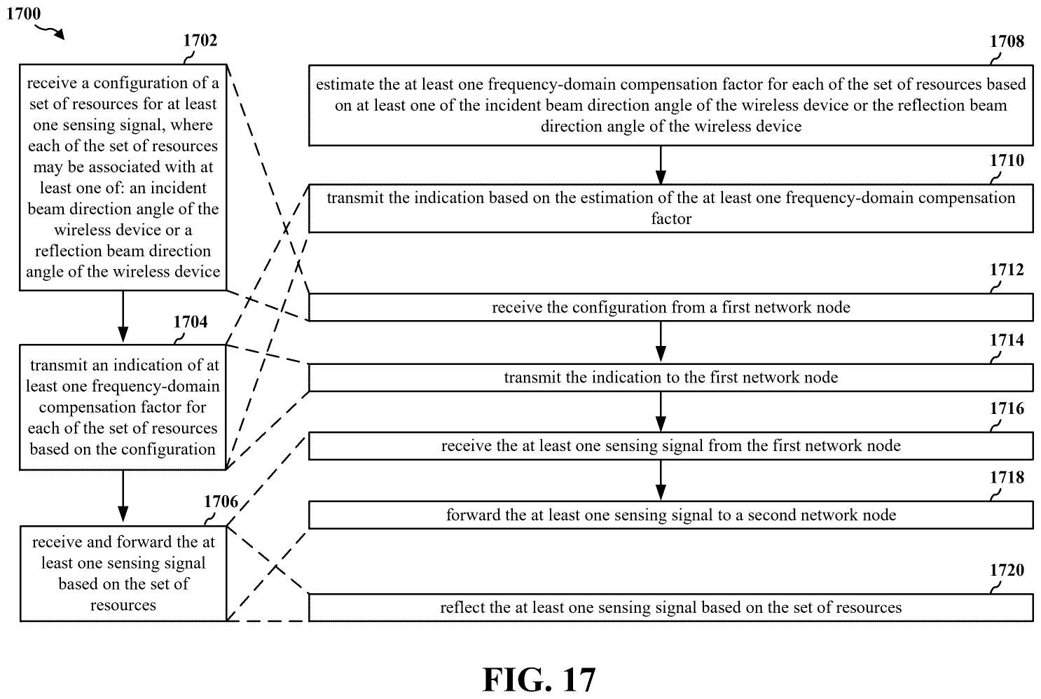

FIG. 17 is a flowchart 1700 of a method of wireless communication. The method may be performed by a wireless device (e.g., the RIS 106, the RIS 404, the RIS 504, the RIS 604, the RIS 704, the RIS 804, the RIS 904, the RIS 1004, the RIS 1104, the RIS 1204). At 1702, the wireless device may receive a configuration of a set of resources for at least one sensing signal. Each of the set of resources may be associated with at least one of: an incident beam direction angle of the wireless device or a reflection beam direction angle of the wireless device. For example, 1702 may be performed by the RIS 804 in FIG. 8, which may receive the sensing signal configuration 812 of a set of resources for the sensing signal 818. Each of the set of resources configured by the sensing signal configuration 812 may be associated with at least one of an incident beam direction angle of the RIS 804 or a reflection beam direction angle of the RIS 804. Moreover, 1702 may be performed by the component 197 in FIG. 4.

At 1704, the wireless device may transmit an indication of at least one frequency-domain compensation factor for each of the set of resources based on the configuration. For example, 1704 may be performed by the RIS 804 in FIG. 8, which may transmit an indication 816 of the set of frequency-compensation factors for each of the set of resources based on the sensing signal configuration 812. Moreover, 1704 may be performed by the component 197 in FIG. 4.

At 1706, the wireless device may receive and forward the at least one sensing signal based on the set of resources. For example, 1706 may be performed by the RIS 804 in FIG. 8, which may receive and forward the sensing signal 818 based on the set of resources configured by the sensing signal configuration 812. Moreover, 1706 may be performed by the component 197 in FIG. 4.

At 1708, the wireless device may estimate the at least one frequency-domain compensation factor for each of the set of resources based on at least one of the incident beam direction angle of the wireless device or the reflection beam direction angle of the wireless device. For example, 1708 may be performed by the RIS 804 in FIG. 8, which may, at 814, estimate the set of frequency-compensation factors for each of the set of resources based on at least one of the incident beam direction angle of the RIS 804 or the reflection beam direction angle of the RIS 804. The RIS 804 may estimate at least one of the set of frequency-domain compensation factors as a product of a first frequency-domain compensation factor of a DL reflection and a second frequency-domain compensation factor of a UL reflection.

Moreover, 1708 may be performed by the component 197 in FIG. 4.

At 1710, the wireless device may transmit the indication based on the estimation of the at least one frequency-domain compensation factor. For example, 1710 may be performed by the RIS 804 in FIG. 8, which may transmit the indication 816 of the set of frequency-compensation factors to the target object 805 based on the estimation at 814. Moreover, 1710 may be performed by the component 197 in FIG. 4.

At 1712, the wireless device may receive the configuration from a first network node. For example, 1712 may be performed by the RIS 804 in FIG. 8, which may receive the sensing signal configuration 812 from the network node 802. Moreover, 1712 may be performed by the component 197 in FIG. 4.

At 1714, the wireless device may transmit the indication to the first network node. For example, 1714 may be performed by the RIS 1004 in FIG. 10, which may transmit the indication 1016 to the network node 1002. Moreover, 1714 may be performed by the component 197 in FIG. 4.

At 1716, the wireless device may receive the at least one sensing signal from the first network node. For example, 1716 may be performed by the RIS 804 in FIG. 8, which may receive the sensing signal 818 from the network node 802. Moreover, 1716 may be performed by the component 197 in FIG. 4.

At 1718, the wireless device may forward the at least one sensing signal to a second network node. For example, 1718 may be performed by the RIS 804 in FIG. 8, which may forward the sensing signal 818 to the network node 806 via the target object 805 as the sensing signal 820. 1718 may also be performed by the RIS 704 in FIG. 7, which may forward the sensing signal 718 to the network node 706 as the sensing signal 720. Moreover, 1718 may be performed by the component 197 in FIG. 4.

At 1720, the wireless device may reflect the at least one sensing signal based on the set of resources. For example, 1720 may be performed by the RIS 804 in FIG. 8, which may reflect the sensing signal 818 as the sensing signal 820 based on the set of resources. Moreover, 1720 may be performed by the component 197 in FIG. 4.

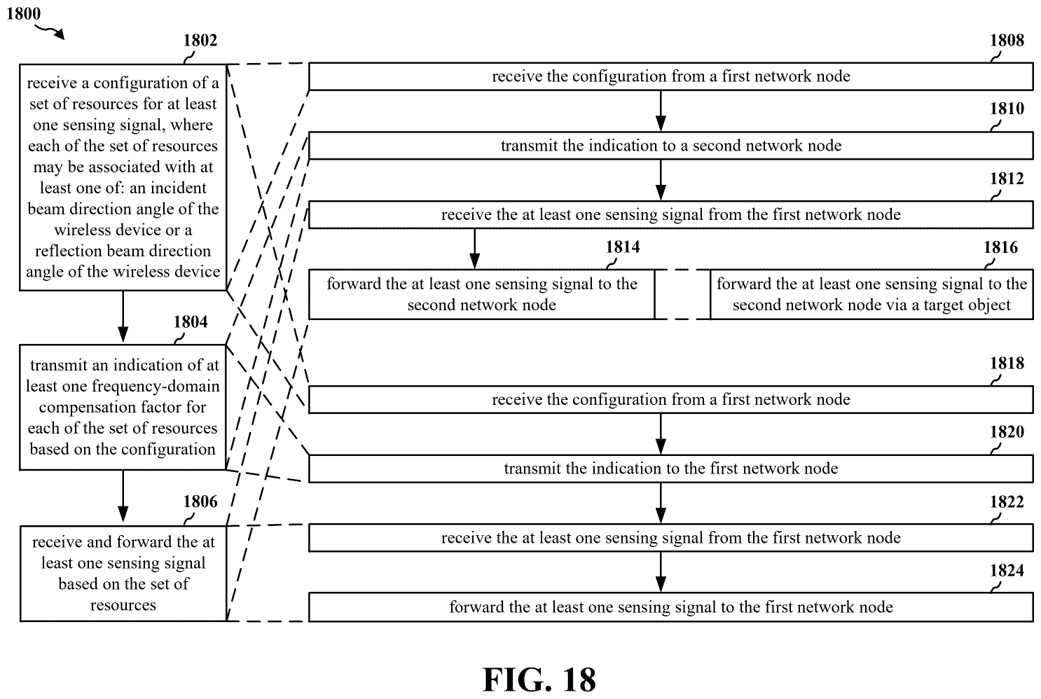

FIG. 18 is a flowchart 1800 of a method of wireless communication. The method may be performed by a wireless device (e.g., the RIS 106, the RIS 404, the RIS 504, the RIS 604, the RIS 704, the RIS 804, the RIS 904, the RIS 1004, the RIS 1104, the RIS 1204). At 1802, the wireless device may receive a configuration of a set of resources for at least one sensing signal. Each of the set of resources may be associated with at least one of: an incident beam direction angle of the wireless device or a reflection beam direction angle of the wireless device. For example, 1802 may be performed by the RIS 804 in FIG. 8, which may receive the sensing signal configuration 812 of a set of resources for the sensing signal 818. Each of the set of resources configured by the sensing signal configuration 812 may be associated with at least one of an incident beam direction angle of the RIS 804 or a reflection beam direction angle of the RIS 804. Moreover, 1802 may be performed by the component 197 in FIG. 4.

At 1804, the wireless device may transmit an indication of at least one frequency-domain compensation factor for each of the set of resources based on the configuration. For example, 1804 may be performed by the RIS 804 in FIG. 8, which may transmit an indication 816 of the set of frequency-compensation factors for each of the set of resources based on the sensing signal configuration 812. Moreover, 1804 may be performed by the component 197 in FIG. 4.

At 1806, the wireless device may receive and forward the at least one sensing signal based on the set of resources. For example, 1806 may be performed by the RIS 804 in FIG. 8, which may receive and forward the sensing signal 818 based on the set of resources configured by the sensing signal configuration 812. Moreover, 1806 may be performed by the component 197 in FIG. 4.

At 1808, the wireless device may receive the configuration from a first network node. For example, 1808 may be performed by the RIS 804 in FIG. 8, which may receive the sensing signal configuration 812 from the network node 802. Moreover, 1808 may be performed by the component 197 in FIG. 4.

At 1810, the wireless device may transmit the indication to a second network node. For example, 1810 may be performed by the RIS 804 in FIG. 8, which may transmit the indication 816 of the set of frequency-compensation factors to the network node 806 via the target object 805. 1810 may also be performed by the RIS 704 in FIG. 7, which may transmit the indication 716 of the set of frequency-compensation factors to the network node 706. Moreover, 1810 may be performed by the component 197 in FIG. 4.

At 1812, the wireless device may receive the at least one sensing signal from the first network node. For example, 1812 may be performed by the RIS 804 in FIG. 8, which may receive the sensing signal 818 from the network node 802. Moreover, 1812 may be performed by the component 197 in FIG. 4.

At 1814, the wireless device may forward the at least one sensing signal to the second network node. For example, 1814 may be performed by the RIS 804 in FIG. 8, which may forward the sensing signal 818 to the network node 806 as the sensing signal 820 via the target object 805. 1814 may also be performed by the RIS 704, which may forward the sensing signal 718 to the network node 706 as the sensing signal 720. Moreover, 1814 may be performed by the component 197 in FIG. 4.

At 1816, the wireless device may forward the at least one sensing signal to the second network node via a target object. For example, 1816 may be performed by the RIS 804 in FIG. 8, which may forward the sensing signal 818 to the network node 806 via the target object 805. Moreover, 1816 may be performed by the component 197 in FIG. 4.

At 1818, the wireless device may receive the configuration from a first network node. For example, 1818 may be performed by the RIS 804 in FIG. 8, which may receive the sensing signal configuration 812 from the network node 802. Moreover, 1818 may be performed by the component 197 in FIG. 4.

At 1820, the wireless device may transmit the indication to the first network node. For example, 1820 may be performed by the RIS 1004 in FIG. 10, which may transmit the indication 1016 of the set of frequency-compensation factors to the network node 1002. Moreover, 1820 may be performed by the component 197 in FIG. 4.

At 1822, the wireless device may receive the at least one sensing signal from the first network node. For example, 1822 may be performed by the RIS 804 in FIG. 8, which may receive the sensing signal 818 from the network node 802. Moreover, 1822 may be performed by the component 197 in FIG. 4.

At 1824, the wireless device may forward the at least one sensing signal to the first network node. For example, 1824 may be performed by the RIS 1104 in FIG. 11, which may forward the sensing signal 1119 to the network node 1102 as the sensing signal 1121. Moreover, 1824 may be performed by the component 197 in FIG. 4.

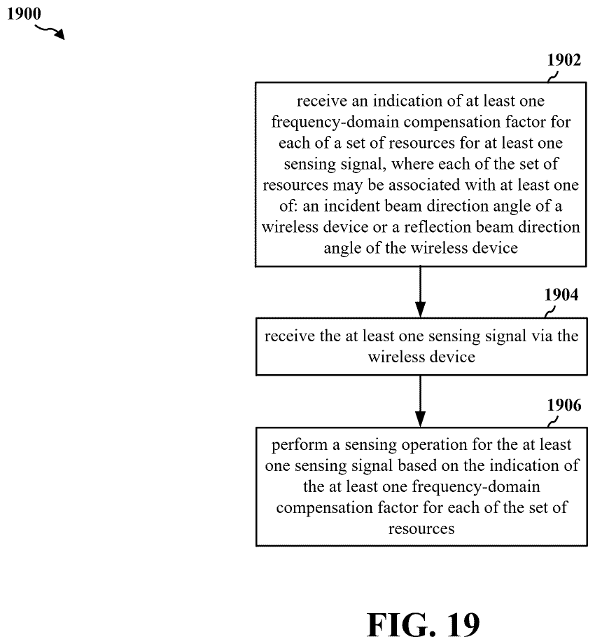

FIG. 19 is a flowchart 1900 of a method of wireless communication. The method may be performed by a second network node (e.g., the UE 104, the UE 350; the base station 102, the base station 310; the network node 406, the network node 506, the network node 606, the network node 706, the network node 806, the network node 906, the network node 1102, the network node 1202; the network entity 2102, the network entity 2202, the network entity 2360). At 1902, the second network node may receive an indication of at least one frequency-domain compensation factor for each of a set of resources for at least one sensing signal. Each of the set of resources may be associated with at least one of: an incident beam direction angle of a wireless device or a reflection beam direction angle of the wireless device. For example, 1902 may be performed by the network node 806 in FIG. 8, which may receive an indication 817 of the set of frequency-domain compensation factors for each of a set of resources for the sensing signal 821. Each of the set of resources may be associated with at least one of an incident beam direction angle of the RIS 804 or a reflection beam direction angle of the RIS 804. Moreover, 1902 may be performed by the component 199 in FIGS. 21-23.

At 1904, the second network node may receive the at least one sensing signal via the wireless device. For example, 1904 may be performed by the network node 806 in FIG. 8, which may receive the sensing signal 821 via the RIS 804. Moreover, 1904 may be performed by the component 199 in FIGS. 21-23.

At 1906, the second network node may perform a sensing operation for the at least one sensing signal based on the indication of the at least one frequency-domain compensation factor for each of the set of resources. For example, 1906 may be performed by the network node 806 in FIG. 8, which may, at 822, perform a sensing operation for the sensing signal 821 based on the indication 817 of the set of frequency-domain compensation factors for each of the set of resources. Moreover, 1906 may be performed by the component 199 in FIGS. 21-23.

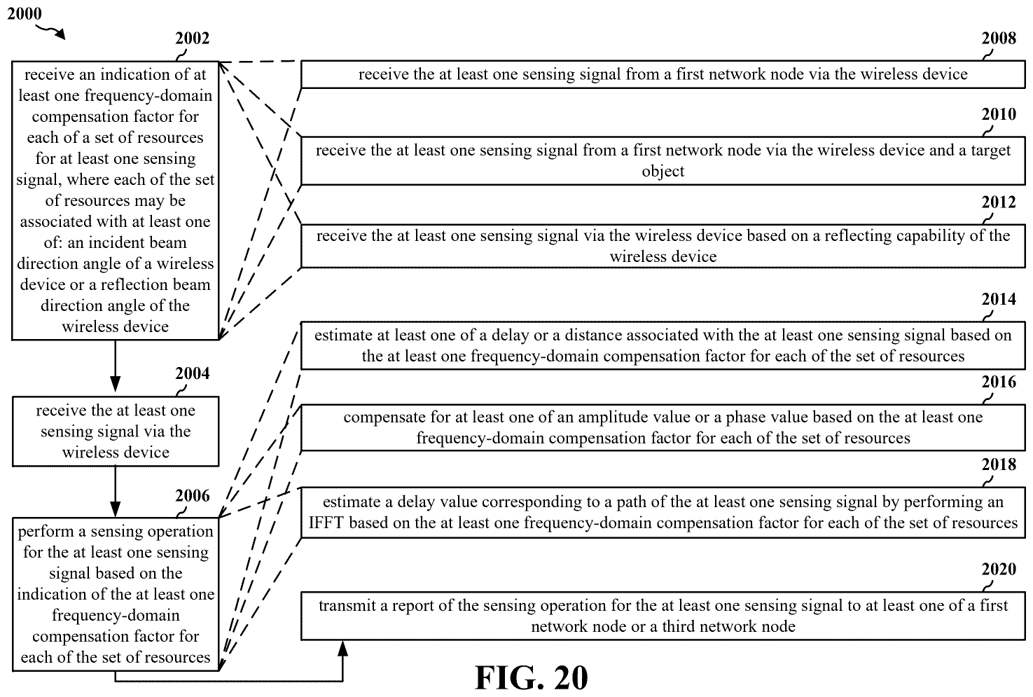

FIG. 20 is a flowchart 2000 of a method of wireless communication. The method may be performed by a second network node (e.g., the UE 104, the UE 350; the base station 102, the base station 310; the network node 406, the network node 506, the network node 606, the network node 706, the network node 806, the network node 906, the network node 1102, the network node 1202; the network entity 2102, the network entity 2202, the network entity 2360). At 2002, the second network node may receive an indication of at least one frequency-domain compensation factor for each of a set of resources for at least one sensing signal. Each of the set of resources may be associated with at least one of: an incident beam direction angle of a wireless device or a reflection beam direction angle of the wireless device. For example, 2002 may be performed by the network node 806 in FIG. 8, which may receive an indication 817 of the set of frequency-domain compensation factors for each of a set of resources for the sensing signal 821. Each of the set of resources may be associated with at least one of an incident beam direction angle of the RIS 804 or a reflection beam direction angle of the RIS 804. Moreover, 2002 may be performed by the component 199 in FIGS. 21-23.

At 2004, the second network node may receive the at least one sensing signal via the wireless device. For example, 2004 may be performed by the network node 806 in FIG. 8, which may receive the sensing signal 821 via the RIS 804. Moreover, 2004 may be performed by the component 199 in FIGS. 21-23.

At 2006, the second network node may perform a sensing operation for the at least one sensing signal based on the indication of the at least one frequency-domain compensation factor for each of the set of resources. For example, 2006 may be performed by the network node 806 in FIG. 8, which may, at 822, perform a sensing operation for the sensing signal 821 based on the indication 817 of the set of frequency-domain compensation factors for each of the set of resources. Moreover, 2006 may be performed by the component 199 in FIGS. 21-23.

At 2008, the second network node may receive the at least one sensing signal from a first network node via the wireless device. For example, 2008 may be performed by the network node 806 in FIG. 8, which may receive the sensing signal 821 from the network node 802 via the RIS 804. 2008 may also be performed by the network node 706 in FIG. 7, which may receive the sensing signal 720 from the network node 702 via the RIS 704. Moreover, 2008 may be performed by the component 199 in FIGS. 21-23.

At 2010, the second network node may receive the at least one sensing signal from a first network node via the wireless device and a target object. For example, 2010 may be performed by the network node 806 in FIG. 8, which may receive the sensing signal 821 from the network node 802 via the RIS 804 and the target object 805. Moreover, 2010 may be performed by the component 199 in FIGS. 21-23.

At 2012, the second network node may receive the at least one sensing signal via the wireless device based on a reflecting capability of the wireless device. For example, 2012 may be performed by the network node 806 in FIG. 8, which may receive the sensing signal 821 via the RIS 804 based on a reflecting capability of the RIS 804. 2012 may also be performed by the network node 706 in FIG. 7, which may receive the sensing signal 720 via the RIS 704 based on a reflecting capability of the RIS 704. Moreover, 2012 may be performed by the component 199 in FIGS. 21-23.

At 2014, the second network node may estimate at least one of a delay or a distance associated with the at least one sensing signal based on the at least one frequency-domain compensation factor for each of the set of resources. For example, 2014 may be performed by the network node 806 in FIG. 8, which may, at 822, estimate at least one of a delay or a distance associated with the sensing signal 821 based on the indication 817 of the set of frequency-compensation factors for each of the set of resources. Moreover, 2014 may be performed by the component 199 in FIGS. 21-23.

At 2016, the second network node may compensate for at least one of an amplitude value or a phase value based on the at least one frequency-domain compensation factor for each of the set of resources. For example, 2016 may be performed by the network node 806 in FIG. 8, which may compensate for at least one of an amplitude value or a phase value based on the indication 817 of the set of frequency-domain compensation factors for each of the set of resources. Moreover, 2016 may be performed by the component 199 in FIGS. 21-23.

At 2018, the second network node may estimate a delay value corresponding to a path of the at least one sensing signal by performing an IFFT based on the at least one frequency-domain compensation factor for each of the set of resources. For example, 2018 may be performed by the network node 806 in FIG. 8, which may estimate a delay value corresponding to a path of the sensing signal 821 by performing an IFFT based on the indication 817 of the set of frequency-domain compensation factors for each of the set of resources. Moreover, 2018 may be performed by the component 199 in FIGS. 21-23.

At 2020, the second network node may transmit a report of the sensing operation for the at least one sensing signal to at least one of a first network node or a third network node. For example, 2020 may be performed by the network node 806 in FIG. 8, which may transmit the sensing result report 824 for the sensing signal 821 to the network node 802 via the RIS 804 and the target object 805. 2020 may also be performed by the network node 906 in FIG. 9, which may transmit the sensing result report 924 for the sensing signal 921 to the network node 902. Any of the network nodes 606, 706, 806, 906, or 1006 may be configured to transmit the sensing result report 624, 724, 824, 924, or 1024 to another network node. Moreover, 2020 may be performed by the component 199 in FIGS. 21-23.

FIG. 21 is a diagram 2100 illustrating an example of a hardware implementation for an apparatus 2104. The apparatus 2104 may be a UE, a component of a UE, or may implement UE functionality. In some aspects, the apparatus 1504 may include a cellular baseband processor 2124 (also referred to as a modem) coupled to one or more transceivers 2122 (e.g., cellular RF transceiver). The cellular baseband processor 2124 may include on-chip memory 2124′. In some aspects, the apparatus 2104 may further include one or more subscriber identity modules (SIM) cards 2120 and an application processor 2106 coupled to a secure digital (SD) card 2108 and a screen 2110. The application processor 2106 may include on-chip memory 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (Rx)). The Bluetooth module 2112, the WLAN module 2114, and the SPS module 2116 may include their own dedicated antennas and/or utilize the antennas 2180 for communication. The cellular baseband processor 2124 communicates through the transceiver(s) 2122 via one or more antennas 2180 with the UE 104 and/or with an RU associated with a network entity 2102. The cellular baseband processor 2124 and the application processor 2106 may each include a computer-readable medium/memory 2124′, 2106′, respectively. The additional memory modules 2126 may also be considered a computer-readable medium/memory. Each computer-readable medium/memory 2124′, 2106′, 2126 may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The computer-readable medium/memory may also be used for storing data that is manipulated by the cellular baseband processor 2124/application processor 2106 when executing software. The cellular baseband processor 2124/application processor 2106 may be a component of the UE 350 and may include the memory 360 and/or at least one of the Tx processor 368, the Rx processor 356, and the controller/processor 359. In one configuration, the apparatus 2104 may be a processor chip (modem and/or application) and include just the cellular baseband processor 2124 and/or the application processor 2106, and in another configuration, the apparatus 2104 may be the entire UE (e.g., see UE 350 of FIG. 3) and include the additional modules of the apparatus 2104.

As discussed supra, the component 198 is configured to transmit a configuration of a set of resources for at least one sensing signal. Each of the set of resources may be associated with at least one of an incident beam direction angle of a wireless device or a reflection beam direction angle of the wireless device. The component 198 may be configured to transmit the at least one sensing signal based on the configuration of the set of resources. The component 198 may be within the cellular baseband processor 2124, the application processor 2106, or both the cellular baseband processor 2124 and the application processor 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2104 may include a variety of components configured for various functions. In one configuration, the apparatus 2104, and in particular the cellular baseband processor 2124 and/or the application processor 2106, includes means for transmitting a configuration of a set of resources for at least one sensing signal. The apparatus 2104 may include means for transmitting the at least one sensing signal based on the configuration of the set of resources. The apparatus 2104 may include means for configuring the set of resources for the at least one sensing signal. The apparatus 2104 may include means for transmitting the configuration of the set of resources for the at least one sensing signal by transmitting the configuration of the set of resources based on the configured set of resources. The apparatus 2104 may include means for transmitting the configuration of the set of resources by transmitting the configuration of the set of resources to the wireless device. The apparatus 2104 may include means for where transmitting the at least one sensing signal based on the configuration of the set of resources by transmitting the at least one sensing signal to a second network node via the wireless device. The apparatus 2104 may include means for receiving a report of a sensing operation for the at least one sensing signal from a second network node. The apparatus 2104 may include means for receiving an indication of at least one frequency-domain compensation factor for each of the set of resources for the at least one sensing signal. The apparatus 2104 may include means for outputting the indication of the at least one frequency-domain compensation factor for each of the set of resources for the at least one sensing signal to a second network node. The apparatus 2104 may include means for transmitting the at least one sensing signal based on the configuration of the set of resources by transmitting the at least one sensing signal to the first network node via the wireless device. The apparatus 2104 may include means for receiving an indication of at least one frequency-domain compensation factor for each of the set of resources for the at least one sensing signal. The apparatus 2104 may include means for receiving a reflection of the at least one sensing signal based on reflecting via the wireless device. The apparatus 2104 may include means for performing a sensing operation for the reflection of the at least one sensing signal based on the indication of the at least one frequency-domain compensation factor for each of the set of resources. The apparatus 2104 may include means for estimating at least one of the incident beam direction angle of the wireless device or the reflection beam direction angle of the wireless device based on a first location indication of the wireless device and a second location indication of the first network node. The means may be the component 198 of the apparatus 2104 configured to perform the functions recited by the means. As described supra, the apparatus 2104 may include the Tx processor 368, the Rx processor 356, and the controller/processor 359. As such, in one configuration, the means may be the Tx processor 368, the Rx processor 356, and/or the controller/processor 359 configured to perform the functions recited by the means.

As discussed supra, the component 199 is configured receive an indication of at least one frequency-domain compensation factor for each of a set of resources for at least one sensing signal. Each of the set of resources may be associated with at least one of: an incident beam direction angle of a wireless device or a reflection beam direction angle of the wireless device. The component 199 may be configured to transmit the at least one sensing signal based on the configuration of the set of resources. The component 199 may be within the cellular baseband processor 2124, the application processor 2106, or both the cellular baseband processor 2124 and the application processor 2106. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2104 may include a variety of components configured for various functions. In one configuration, the apparatus 2104, and in particular the cellular baseband processor 2124 and/or the application processor 2106, includes means for receiving the at least one sensing signal via the wireless device by the at least one sensing signal from a first network node via the wireless device and a target object. The apparatus 2104 may include means for receiving the at least one sensing signal via the wireless device by receiving the at least one sensing signal via the wireless device based on a reflecting capability of the wireless device. The apparatus 2104 may include means for transmitting a report of the sensing operation for the at least one sensing signal to a first network node or a third network node. The apparatus 2104 may include means for performing the sensing operation for the at least one sensing signal based on the indication of the at least one frequency-domain compensation factor by estimating at least one of a delay or a distance associated with the at least one sensing signal based on the at least one frequency-domain compensation factor for each of the set of resources. The apparatus 2104 may include means for performing the sensing operation for the at least one sensing signal based on the indication of the at least one frequency-domain compensation factor by compensating for at least one of an amplitude value or a phase value based on the at least one frequency-domain compensation factor for each of the set of resources. The apparatus 2104 may include means for performing the sensing operation for the at least one sensing signal based on the indication of the at least one frequency-domain compensation factor by estimating a delay value corresponding to a path of the at least one sensing signal by performing an IFFT based on the at least one frequency-domain compensation factor for each of the set of resources. The means may be the component 199 of the apparatus 2104 configured to perform the functions recited by the means. As described supra, the apparatus 2104 may include the Tx processor 368, the Rx processor 356, and the controller/processor 359. As such, in one configuration, the means may be the Tx processor 368, the Rx processor 356, and/or the controller/processor 359 configured to perform the functions recited by the means.

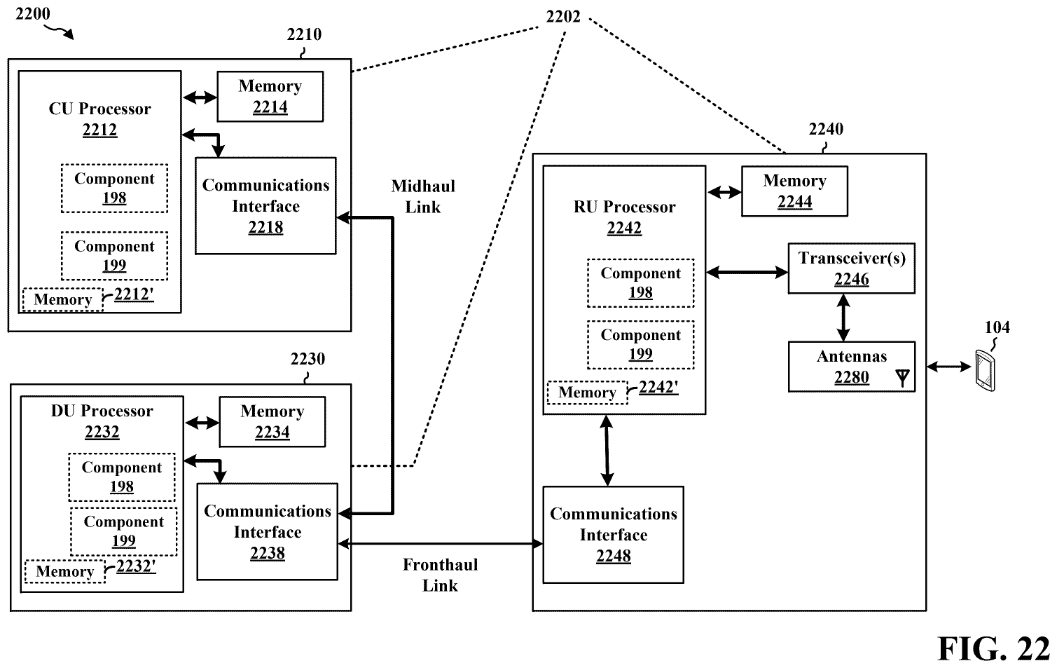

FIG. 22 is a diagram 2200 illustrating an example of a hardware implementation for a network entity 2202. The network entity 2202 may be a BS, a component of a BS, or may implement BS functionality. The network entity 2202 may include at least one of a CU 2210, a DU 2230, or an RU 2240. For example, depending on the layer functionality handled by the component 199, the network entity 2202 may include the CU 2210; both the CU 2210 and the DU 2230; each of the CU 2210, the DU 2230, and the RU 2240; the DU 2230; both the DU 2230 and the RU 2240; or the RU 2240. The CU 2210 may include a CU processor 2212. The CU processor 2212 may include on-chip memory 2212′. In some aspects, the CU 2210 may further include additional memory modules 2214 and a communications interface 2218. The CU 2210 communicates with the DU 2230 through a midhaul link, such as an F1 interface. The DU 2230 may include a DU processor 2232. The DU processor 2232 may include on-chip memory 2232′. In some aspects, the DU 2230 may further include additional memory modules 2234 and a communications interface 2238. The DU 2230 communicates with the RU 2240 through a fronthaul link. The RU 2240 may include an RU processor 2242. The RU processor 2242 may include on-chip memory 2242′. In some aspects, the RU 2240 may further include additional memory modules 2244, one or more transceivers 2246, antennas 2280, and a communications interface 2248. The RU 2240 communicates with the UE 104. The on-chip memory 2212′, 2232′, 2242′ and the additional memory modules 2214, 2234, 2244 may each be considered a computer-readable medium/memory. Each computer-readable medium/memory may be non-transitory. Each of the processors 2212, 2232, 2242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 is configured to transmit a configuration of a set of resources for at least one sensing signal. Each of the set of resources may be associated with at least one of an incident beam direction angle of a wireless device or a reflection beam direction angle of the wireless device. The component 198 may be configured to transmit the at least one sensing signal based on the configuration of the set of resources. The component 198 may be within one or more processors of one or more of the CU 2210, DU 2230, and the RU 2240. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2202 may include a variety of components configured for various functions. In one configuration, the network entity 2202 includes means for transmitting the at least one sensing signal based on the configuration of the set of resources. The network entity 2202 may include means for configuring the set of resources for the at least one sensing signal. The network entity 2202 may include means for transmitting the configuration of the set of resources for the at least one sensing signal by transmitting the configuration of the set of resources based on the configured set of resources. The network entity 2202 may include means for transmitting the configuration of the set of resources by transmitting the configuration of the set of resources to the wireless device. The network entity 2202 may include means for where transmitting the at least one sensing signal based on the configuration of the set of resources by transmitting the at least one sensing signal to a second network node via the wireless device. The network entity 2202 may include means for receiving a report of a sensing operation for the at least one sensing signal from a second network node. The network entity 2202 may include means for receiving an indication of at least one frequency-domain compensation factor for each of the set of resources for the at least one sensing signal. The network entity 2202 may include means for outputting the indication of the at least one frequency-domain compensation factor for each of the set of resources for the at least one sensing signal to a second network node. The network entity 2202 may include means for transmitting the at least one sensing signal based on the configuration of the set of resources by transmitting the at least one sensing signal to the first network node via the wireless device. The network entity 2202 may include means for receiving an indication of at least one frequency-domain compensation factor for each of the set of resources for the at least one sensing signal. The network entity 2202 may include means for receiving a reflection of the at least one sensing signal based on reflecting via the wireless device. The network entity 2202 may include means for performing a sensing operation for the reflection of the at least one sensing signal based on the indication of the at least one frequency-domain compensation factor for each of the set of resources. The network entity 2202 may include means for estimating at least one of the incident beam direction angle of the wireless device or the reflection beam direction angle of the wireless device based on a first location indication of the wireless device and a second location indication of the first network node. The means may be the component 198 of the network entity 2202 configured to perform the functions recited by the means. As described supra, the network entity 2202 may include the Tx processor 316, the Rx processor 370, and the controller/processor 375. As such, in one configuration, the means may be the Tx processor 316, the Rx processor 370, and/or the controller/processor 375 configured to perform the functions recited by the means.

As discussed supra, the component 199 is configured to receive an indication of at least one frequency-domain compensation factor for each of a set of resources for at least one sensing signal. Each of the set of resources may be associated with at least one of: an incident beam direction angle of a wireless device or a reflection beam direction angle of the wireless device. The component 199 may be configured to receive the at least one sensing signal via the wireless device. The component 199 may be configured to perform a sensing operation for the at least one sensing signal based on the indication of the at least one frequency-domain compensation factor for each of the set of resources. The component 199 may be within one or more processors of one or more of the CU 2210, DU 2230, and the RU 2240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2202 may include a variety of components configured for various functions. In one configuration, the network entity 2202 includes means for receiving an indication of at least one frequency-domain compensation factor for each of a set of resources for at least one sensing signal. The network entity 2202 may include means for receiving the at least one sensing signal via the wireless device. The network entity 2202 may include means for performing a sensing operation for the at least one sensing signal based on the indication of the at least one frequency-domain compensation factor for each of the set of resources. The network entity 2202 may include means for receiving the at least one sensing signal via the wireless device by receiving the at least one sensing signal from a first network node via the wireless device. The network entity 2202 may include means for receiving the at least one sensing signal via the wireless device by the at least one sensing signal from a first network node via the wireless device and a target object. The network entity 2202 may include means for receiving the at least one sensing signal via the wireless device by receiving the at least one sensing signal via the wireless device based on a reflecting capability of the wireless device. The network entity 2202 may include means for transmitting a report of the sensing operation for the at least one sensing signal to a first network node or a third network node. The network entity 2202 may include means for performing the sensing operation for the at least one sensing signal based on the indication of the at least one frequency-domain compensation factor by estimating at least one of a delay or a distance associated with the at least one sensing signal based on the at least one frequency-domain compensation factor for each of the set of resources. The network entity 2202 may include means for performing the sensing operation for the at least one sensing signal based on the indication of the at least one frequency-domain compensation factor by compensating for at least one of an amplitude value or a phase value based on the at least one frequency-domain compensation factor for each of the set of resources. The network entity 2202 may include means for performing the sensing operation for the at least one sensing signal based on the indication of the at least one frequency-domain compensation factor by estimating a delay value corresponding to a path of the at least one sensing signal by performing an IFFT based on the at least one frequency-domain compensation factor for each of the set of resources. The means may be the component 199 of the network entity 2202 configured to perform the functions recited by the means. As described supra, the network entity 2202 may include the Tx processor 316, the Rx processor 370, and the controller/processor 375. As such, in one configuration, the means may be the Tx processor 316, the Rx processor 370, and/or the controller/processor 375 configured to perform the functions recited by the means.

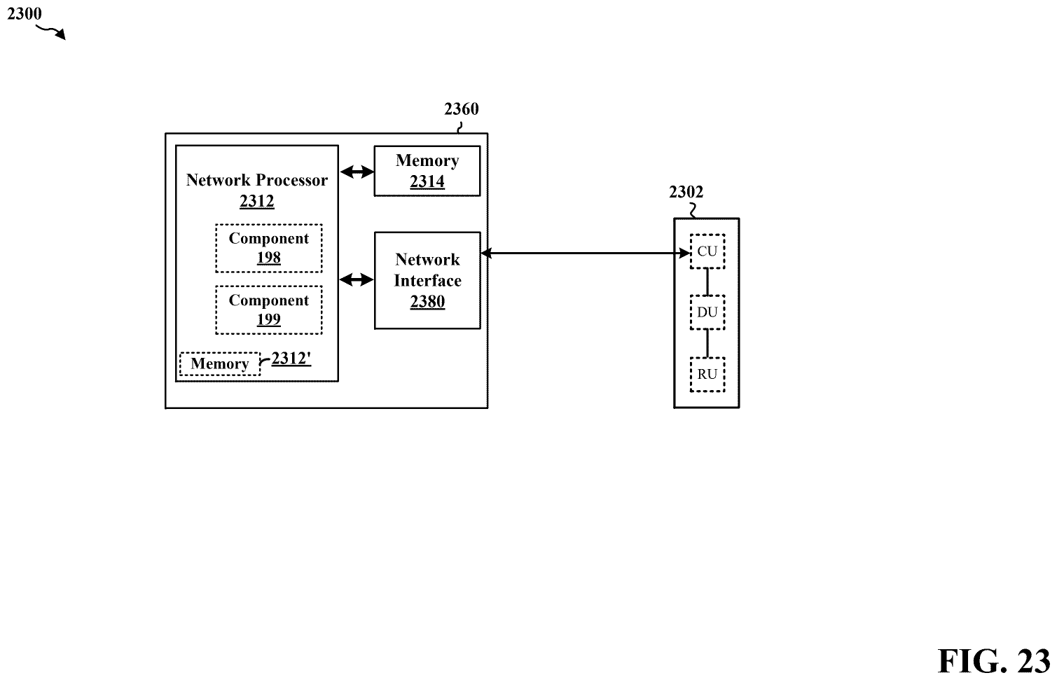

FIG. 23 is a diagram 2300 illustrating an example of a hardware implementation for a network entity 2360. In one example, the network entity 2360 may be within the core network 120. The network entity 2360 may include a network processor 2312. The network processor 2312 may include on-chip memory 2312′. In some aspects, the network entity 2360 may further include additional memory modules 2314. The network entity 2360 communicates via the network interface 2380 directly (e.g., backhaul link) or indirectly (e.g., through a RIC) with the CU 2302. The on-chip memory 2312′ and the additional memory modules 2314 may each be considered a computer-readable medium/memory. Each computer-readable medium/memory may be non-transitory. The processor 2312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 is configured to transmit a configuration of a set of resources for at least one sensing signal. Each of the set of resources may be associated with at least one of an incident beam direction angle of a wireless device or a reflection beam direction angle of the wireless device. The component 198 may be configured to transmit the at least one sensing signal based on the configuration of the set of resources. The component 198 may be within the processor 2312. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2360 may include a variety of components configured for various functions. In one configuration, the network entity 2360 includes means for transmitting a configuration of a set of resources for at least one sensing signal. The network entity 2360 may include means for transmitting the at least one sensing signal based on the configuration of the set of resources. The network entity 2360 may include means for configuring the set of resources for the at least one sensing signal. The network entity 2360 may include means for transmitting the configuration of the set of resources for the at least one sensing signal by transmitting the configuration of the set of resources based on the configured set of resources. The network entity 2360 may include means for transmitting the configuration of the set of resources by transmitting the configuration of the set of resources to the wireless device. The network entity 2360 may include means for where transmitting the at least one sensing signal based on the configuration of the set of resources by transmitting the at least one sensing signal to a second network node via the wireless device. The network entity 2360 may include means for receiving a report of a sensing operation for the at least one sensing signal from a second network node. The network entity 2360 may include means for receiving an indication of at least one frequency-domain compensation factor for each of the set of resources for the at least one sensing signal. The network entity 2360 may include means for outputting the indication of the at least one frequency-domain compensation factor for each of the set of resources for the at least one sensing signal to a second network node. The network entity 2360 may include means for transmitting the at least one sensing signal based on the configuration of the set of resources by transmitting the at least one sensing signal to the first network node via the wireless device. The network entity 2360 may include means for receiving an indication of at least one frequency-domain compensation factor for each of the set of resources for the at least one sensing signal. The network entity 2360 may include means for receiving a reflection of the at least one sensing signal based on reflecting via the wireless device. The network entity 2360 may include means for performing a sensing operation for the reflection of the at least one sensing signal based on the indication of the at least one frequency-domain compensation factor for each of the set of resources. The network entity 2360 may include means for estimating at least one of the incident beam direction angle of the wireless device or the reflection beam direction angle of the wireless device based on a first location indication of the wireless device and a second location indication of the first network node. The means may be the component 198 of the network entity 2360 configured to perform the functions recited by the means.

As discussed supra, the component 199 is configured to receive an indication of at least one frequency-domain compensation factor for each of a set of resources for at least one sensing signal. Each of the set of resources may be associated with at least one of: an incident beam direction angle of a wireless device or a reflection beam direction angle of the wireless device. The component 199 may be configured to transmit the at least one sensing signal based on the configuration of the set of resources. The component 199 may be within the processor 2312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2360 may include a variety of components configured for various functions. In one configuration, the network entity 2360 includes means for receiving the at least one sensing signal via the wireless device by the at least one sensing signal from a first network node via the wireless device and a target object. The network entity 2360 may include means for receiving the at least one sensing signal via the wireless device by receiving the at least one sensing signal via the wireless device based on a reflecting capability of the wireless device. The network entity 2360 may include means for transmitting a report of the sensing operation for the at least one sensing signal to a first network node or a third network node. The network entity 2360 may include means for performing the sensing operation for the at least one sensing signal based on the indication of the at least one frequency-domain compensation factor by estimating at least one of a delay or a distance associated with the at least one sensing signal based on the at least one frequency-domain compensation factor for each of the set of resources. The network entity 2360 may include means for performing the sensing operation for the at least one sensing signal based on the indication of the at least one frequency-domain compensation factor by compensating for at least one of an amplitude value or a phase value based on the at least one frequency-domain compensation factor for each of the set of resources. The network entity 2360 may include means for performing the sensing operation for the at least one sensing signal based on the indication of the at least one frequency-domain compensation factor by estimating a delay value corresponding to a path of the at least one sensing signal by performing an IFFT based on the at least one frequency-domain compensation factor for each of the set of resources. The means may be the component 199 of the network entity 2360 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a first network node, where the method may include transmitting a configuration of a set of resources for at least one sensing signal. Each of the set of resources may be associated with at least one of an incident beam direction angle of a wireless device or a reflection beam direction angle of the wireless device. Each of the set of resources may be associated with at least one of the incident beam direction angle of the wireless device and the reflection beam direction angle of the wireless device. The method may include transmitting the at least one sensing signal based on the configuration of the set of resources. The configuration of the set of resources for the at least one sensing signal may be transmitted to the wireless device. The at least one sensing signal may be transmitted to the wireless device. The wireless device may be capable of sensing a first portion of an incident wave. The wireless device may be capable of reflecting a second portion of the incident wave. The first and second portions may or may not be overlapping.

Aspect 2 is the method of aspect 1, where the method may include configuring the set of resources for the at least one sensing signal. Transmitting the configuration of the set of resources for the at least one sensing signal may include transmitting the configuration of the set of resources based on the configured set of resources.

Aspect 3 is the method of any of aspects 1 and 2, where transmitting the configuration of the set of resources may include transmitting the configuration of the set of resources to the wireless device.

Aspect 4 is the method of any of aspects 1 to 3, where the wireless device may include a RIS.

Aspect 5 is the method of any of aspects 1 to 4, where transmitting the at least one sensing signal based on the configuration of the set of resources may include transmitting the at least one sensing signal to a second network node via the wireless device.

Aspect 6 is the method of any of aspects 1 to 5, where the method may include receiving a report of a sensing operation for the at least one sensing signal from a second network node.

Aspect 7 is the method of any of aspects 1 to 6, where the method may include receiving an indication of at least one frequency-domain compensation factor for each of the set of resources for the at least one sensing signal. The method may include outputting the indication of the at least one frequency-domain compensation factor for each of the set of resources for the at least one sensing signal to a second network node. The indication of the at least one frequency-domain compensation factor may be received from the wireless device.

Aspect 8 is the method of any of aspects 1 to 7, where transmitting the at least one sensing signal based on the configuration of the set of resources may include transmitting the at least one sensing signal to the first network node via the wireless device. The sensing signal may be transmitted to the wireless device, and reflected back to the first network node. The wireless device may reflect the sensing signal to a target object, which reflects the sensing signal back to the wireless device, which then reflects the sensing signal back to the first network node.

Aspect 9 is the method of any of aspects 1 to 8, where the method may include receiving an indication of at least one frequency-domain compensation factor for each of the set of resources for the at least one sensing signal. The method may include receiving a reflection of the at least one sensing signal based on reflecting via the wireless device. The method may include performing a sensing operation for the reflection of the at least one sensing signal based on the indication of the at least one frequency-domain compensation factor for each of the set of resources.

Aspect 10 is the method of any of aspects 1 to 9, where the method may include estimating at least one of the incident beam direction angle of the wireless device or the reflection beam direction angle of the wireless device based on a first location indication of the wireless device and a second location indication of the first network node.

Aspect 11 is a method of wireless communication at a wireless device, where the method may include receiving a configuration of a set of resources for at least one sensing signal. Each of the set of resources may be associated with at least one of: an incident beam direction angle of the wireless device or a reflection beam direction angle of the wireless device. Each of the set of resources may be associated with at least one of the incident beam direction angle of the wireless device and the reflection beam direction angle of the wireless device. The method may include transmitting an indication of at least one frequency-domain compensation factor for each of the set of resources based on the configuration. The method may include receiving and forwarding the at least one sensing signal based on the set of resources. The wireless device may be capable of sensing a first portion of an incident wave. The wireless device may be capable of reflecting a second portion of the incident wave. The first and second portions may or may not be overlapping.

Aspect 12 is the method of aspect 11, where receiving and forwarding the at least one sensing signal based on the set of resources may include reflecting the at least one sensing signal based on the set of resources.

Aspect 13 is the method of any of aspects 11 and 12, where the method may include estimating the at least one frequency-domain compensation factor for each of the set of resources based on at least one of the incident beam direction angle of the wireless device or the reflection beam direction angle of the wireless device. Transmitting the indication of the at least one frequency-domain compensation factor for each of the set of resources based on the configuration may include transmitting the indication based on the estimation of the at least one frequency-domain compensation factor.

Aspect 14 is the method of any aspect 13, where the method may include estimating a frequency-domain compensation factor at an nth element of the wireless device based on

$${h}_{n} = {e}^{j \frac{2 π d n}{λ} ( sin {θ}_{i} + sin {θ}_{r} )} \times {α}_{n} {e}^{j {φ}_{n}} .$$

θᵢ may be the incident beam direction angle of the wireless device. θᵣ may be the reflection beam direction angle of the wireless device. dₙ may be a distance between a first element of the wireless device and the nth element of the wireless device. λ may be a wavelength of the at least one sensing signal. On may be estimated using the formula

$$- \frac{2 π {d}_{n}}{λ} ( sin {θ}_{i} + sin {θ}_{r} ) .$$

Aspect 15 is the method of aspect 13, where estimating the at least one frequency-domain compensation factor as a product of a first frequency-domain compensation factor of an DL reflection and a second frequency-domain compensation factor of a UL reflection.

Aspect 16 is the method of any of aspects 11 to 15, where receiving the configuration of the set of resources for the at least one sensing signal may include receiving the configuration from a first network node. Transmitting the indication of the at least one frequency-domain compensation factor may include transmitting the indication to a second network node. Receiving and forwarding the at least one sensing signal based on the set of resources may include receiving the at least one sensing signal from the first network node. Receiving and forwarding the at least one sensing signal based on the set of resources may include forwarding the at least one sensing signal to the second network node.

Aspect 17 is the method of aspect 16, where forwarding the at least one sensing signal to the second network node may include forwarding the at least one sensing signal to the second network node via a target object.

Aspect 18 is the method of any of aspects 11 to 15, where receiving the configuration of the set of resources for the at least one sensing signal may include receiving the configuration from a first network node. Transmitting the indication of the at least one frequency-domain compensation factor may include transmitting the indication to the first network node. Receiving and forwarding the at least one sensing signal based on the set of resources may include receiving the at least one sensing signal from the first network node. Receiving and forwarding the at least one sensing signal based on the set of resources may include forwarding the at least one sensing signal to the second network node. The first network node may output the indication to the second network node.

Aspect 19 is the method of aspect 18, where forwarding the at least one sensing signal to the second network node may include forwarding the at least one sensing signal to the second network node via a target object.

Aspect 20 is the method of any of aspects 11 to 15, where receiving the configuration of the set of resources for the at least one sensing signal may include receiving the configuration from a first network node. Transmitting the indication of the at least one frequency-domain compensation factor may include transmitting the indication to the first network node. Receiving and forwarding the at least one sensing signal based on the set of resources may include receiving the at least one sensing signal from the first network node. Receiving and forwarding the at least one sensing signal based on the set of resources may include forwarding the at least one sensing signal to the first network node.

Aspect 21 is the method of aspect 20, where forwarding the at least one sensing signal to the first network node may include forwarding the at least one sensing signal to the first network node via a target object that reflects the at least one sensing signal back to the wireless device.

Aspect 22 is a method of wireless communication at a wireless device, where the method may include receiving an indication of at least one frequency-domain compensation factor for each of a set of resources for at least one sensing signal. Each of the set of resources may be associated with at least one of: an incident beam direction angle of a wireless device or a reflection beam direction angle of the wireless device. Each of the set of resources may be associated with at least one of the incident beam direction angle of the wireless device and the reflection beam direction angle of the wireless device. The method may include receiving the at least one sensing signal via the wireless device. The method may include performing a sensing operation for the at least one sensing signal based on the indication of the at least one frequency-domain compensation factor for each of the set of resources. The wireless device may be capable of sensing a first portion of an incident wave. The wireless device may be capable of reflecting a second portion of the incident wave. The first and second portions may or may not be overlapping.

Aspect 23 is the method of aspect 22, where receiving the at least one sensing signal via the wireless device may include receiving the at least one sensing signal from a first network node via the wireless device.

Aspect 24 is the method of any of aspects 22 to 23, where receiving the at least one sensing signal via the wireless device may include receiving the at least one sensing signal from a first network node via the wireless device and a target object.

Aspect 25 is the method of any of aspects 22 to 24, where the wireless device may include a RIS.

Aspect 26 is the method of any of aspects 22 to 25, where receiving the at least one sensing signal via the wireless device may include receiving the at least one sensing signal via the wireless device based on a reflecting capability of the wireless device.

Aspect 27 is the method of any of aspects 22 to 26, where the method may include transmitting a report of the sensing operation for the at least one sensing signal to a first network node or a third network node.

Aspect 28 is the method of aspect 27, where the report may include at least one of a first indication of a delay associated with the at least one sensing signal or a second indication of a distance associated with the at least one sensing signal.

Aspect 29 is the method of any of aspects 22 to 28, where performing the sensing operation for the at least one sensing signal based on the indication of the at least one frequency-domain compensation factor may include estimating at least one of a delay or a distance associated with the at least one sensing signal based on the at least one frequency-domain compensation factor for each of the set of resources.

Aspect 30 is the method of any of aspects 22 to 29, where performing the sensing operation for the at least one sensing signal based on the indication of the at least one frequency-domain compensation factor may include compensating for at least one of an amplitude value or a phase value based on the at least one frequency-domain compensation factor for each of the set of resources.

Aspect 31 is the method of any of aspects 22 to 30, where performing the sensing operation for the at least one sensing signal based on the indication of the at least one frequency-domain compensation factor may include estimating a delay value corresponding to a path of the at least one sensing signal by performing an IFFT based on the at least one frequency-domain compensation factor for each of the set of resources.

Aspect 32 is an apparatus for wireless communication, including: a memory; and at least one processor coupled to the memory and, based at least in part on information stored in the memory, the at least one processor is configured to implement any of aspects 1 to 31.

Aspect 33 is the apparatus of aspect 32, further including at least one of an antenna or a transceiver coupled to the at least one processor.

Aspect 34 is an apparatus for wireless communication including means for implementing any of aspects 1 to 31.

Aspect 35 is a computer-readable medium (e.g., a non-transitory computer-readable medium) storing computer executable code, where the code when executed by a processor causes the processor to implement any of aspects 1 to 31.

1. An apparatus for wireless communication at a first network node, comprising:
memory; and
at least one processor coupled to the memory and, based at least in part on information stored in the memory, the at least one processor is configured to:
transmit a configuration of a set of resources for at least one sensing signal, wherein each of the set of resources is associated with at least one of an incident beam direction angle of a wireless device or a reflection beam direction angle of the wireless device; and
transmit the at least one sensing signal based on the configuration of the set of resources.

2. The apparatus of claim 1, wherein the at least one processor is further configured to:
configure the set of resources for the at least one sensing signal, wherein, to transmit the configuration of the set of resources for the at least one sensing signal, the at least one processor is configured to:
transmit the configuration of the set of resources based on the configured set of resources.

3.-5. (canceled)

6. The apparatus of claim 1, wherein the at least one processor is further configured to:
receive a report of a sensing operation for the at least one sensing signal from a second network node.

7. The apparatus of claim 1, wherein the at least one processor is further configured to:
receive an indication of at least one frequency-domain compensation factor for each of the set of resources for the at least one sensing signal; and
output the indication of the at least one frequency-domain compensation factor for each of the set of resources for the at least one sensing signal to a second network node.

8. (canceled)

9. The apparatus of claim 1, wherein the at least one processor is further configured to:
receive an indication of at least one frequency-domain compensation factor for each of the set of resources for the at least one sensing signal;
receive a reflection of the at least one sensing signal based on reflecting via the wireless device; and
perform a sensing operation for the reflection of the at least one sensing signal based on the indication of the at least one frequency-domain compensation factor for each of the set of resources.

10. The apparatus of claim 1, wherein the at least one processor is further configured to:
estimate at least one of the incident beam direction angle of the wireless device or the reflection beam direction angle of the wireless device based on a first location indication of the wireless device and a second location indication of the first network node.

11. An apparatus for wireless communication at a wireless device, comprising:
memory; and
at least one processor coupled to the memory and, based at least in part on information stored in the memory, the at least one processor is configured to:
receive a configuration of a set of resources for at least one sensing signal, wherein each of the set of resources is associated with at least one of: an incident beam direction angle of the wireless device or a reflection beam direction angle of the wireless device:
transmit an indication of at least one frequency-domain compensation factor for each of the set of resources based on the configuration; and
receive and forward the at least one sensing signal based on the set of resources.

12. The apparatus of claim 11, wherein, to receive and forward the at least one sensing signal based on the set of resources, the at least one processor is configured to reflect the at least one sensing signal based on the set of resources.

13. (canceled)

14. The apparatus of claim 11, wherein the at least one processor is further configured to:
estimate the at least one frequency-domain compensation factor for each of the set of resources based on at least one of the incident beam direction angle of the wireless device or the reflection beam direction angle of the wireless device, wherein, to transmit the indication of the at least one frequency-domain compensation factor for each of the set of resources based on the configuration, the at least one processor is further configured to:
transmit the indication based on the estimation of the at least one frequency-domain compensation factor.

15. The apparatus of claim 14, wherein, to estimate the at least one frequency-domain compensation factor, the at least one processor is further configured to:
estimate the at least one frequency-domain compensation factor as a product of a first frequency-domain compensation factor of a downlink (DL) reflection and a second frequency-domain compensation factor of an uplink (UL) reflection.

16. The apparatus of claim 11, further comprising a transceiver coupled to the at least one processor, wherein, to receive the configuration of the set of resources for the at least one sensing signal, the at least one processor is further configured to:
receive, via the transceiver, the configuration from a first network node, wherein to transmit the indication of the at least one frequency-domain compensation factor, the at least one processor is further configured to:
transmit the indication to a second network node, wherein, to receive and forward the at least one sensing signal based on the set of resources, the at least one processor is further configured to:
receive, via the transceiver, the at least one sensing signal from the first network node; and
forward the at least one sensing signal to the second network node.

17. The apparatus of claim 16, wherein, to forward the at least one sensing signal to the second network node, the at least one processor is further configured to:
forward the at least one sensing signal to the second network node via a target object.

18. The apparatus of claim 11, wherein, to receive the configuration of the set of resources for the at least one sensing signal, the at least one processor is further configured to:
receive the configuration from a first network node, wherein to transmit the indication of the at least one frequency-domain compensation factor, the at least one processor is further configured to:
transmit the indication to the first network node, wherein, to receive and forward the at least one sensing signal based on the set of resources, the at least one processor is further configured to:
receive the at least one sensing signal from the first network node; and
forward the at least one sensing signal to a second network node.

19. The apparatus of claim 11, wherein, to receive the configuration of the set of resources for the at least one sensing signal, the at least one processor is further configured to:
receive the configuration from a first network node, wherein to transmit the indication of the at least one frequency-domain compensation factor, the at least one processor is further configured to:
transmit the indication to the first network node, wherein, to receive and forward the at least one sensing signal based on the set of resources, the at least one processor is further configured to:
receive the at least one sensing signal from the first network node; and
forward the at least one sensing signal to the first network node.

20. An apparatus for wireless communication at a second network node, comprising:
memory; and
at least one processor coupled to the memory and, based at least in part on information stored in the memory, the at least one processor is configured to:
receive an indication of at least one frequency-domain compensation factor for each of a set of resources for at least one sensing signal, wherein each of the set of resources is associated with at least one of: an incident beam direction angle of a wireless device or a reflection beam direction angle of the wireless device:
receive the at least one sensing signal via the wireless device; and
perform a sensing operation for the at least one sensing signal based on the indication of the at least one frequency-domain compensation factor for each of the set of resources.

21.-24. (canceled)

25. The apparatus of claim 20, wherein the at least one processor is further configured to:
transmit a report of the sensing operation for the at least one sensing signal to at least one of a first network node or a third network node.

26. The apparatus of claim 25, wherein the report comprises at least one of a first indication of a delay associated with the at least one sensing signal or a second indication of a distance associated with the at least one sensing signal.

27. The apparatus of claim 20, wherein, to perform the sensing operation for the at least one sensing signal based on the indication of the at least one frequency-domain compensation factor, the at least one processor is configured to:
estimate at least one of a delay or a distance associated with the at least one sensing signal based on the at least one frequency-domain compensation factor for each of the set of resources.

28. The apparatus of claim 20, wherein, to perform the sensing operation for the at least one sensing signal based on the indication of the at least one frequency-domain compensation factor, the at least one processor is configured to:
compensate for at least one of an amplitude value or a phase value based on the at least one frequency-domain compensation factor for each of the set of resources.

29. The apparatus of claim 20, wherein, to perform the sensing operation for the at least one sensing signal based on the indication of the at least one frequency-domain compensation factor, the at least one processor is configured to:
estimate a delay value corresponding to a path of the at least one sensing signal by performing an inverse fast Fourier transform (IFFT) based on the at least one frequency-domain compensation factor for each of the set of resources.

30. (canceled)
